(19) United States
(12) Patent Application Publication
(10) Pub. No.: US 2026/0253575 A1
(43) Pub. Date: Aug. 27, 2026

(54) SYSTEM

(71) Applicant: SoftBank Group Corp., Tokyo (JP)

(72) Inventor: Jinhyeok SIM, Tokyo (JP)

(73) Assignee: SoftBank Group Corp., Tokyo (JP)

(21) Appl. No.: 19/538,997

(22) Filed: Feb. 13, 2026

(30) Foreign Application Priority Data
Feb. 21, 2025 (JP) 2025-027047

(51) Int. Cl. G10L 13/00

(52) U.S. Cl. CPC G10L 13/00

(57) ABSTRACT

The system according to the embodiment comprises a recording unit, an analysis unit, a provision unit, and a voice assist unit. The recording unit records conversation data. The analysis unit analyzes the conversation data recorded by the recording unit. The provision unit provides an alert based on an analysis result obtained by the analysis unit. The voice assist unit speaks in a friendly voice.

### CROSS-REFERENCE TO RELATED APPLICATION

The present application claims priority to and incorporates by reference the entire contents of Japanese Patent Application No. 2025-027047 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, means for effectively reducing health risks and feelings of loneliness among elderly people living alone have not been sufficiently provided, and there is room for improvement.

### SUMMARY OF THE INVENTION

The system according to the embodiment comprises a recording unit, an analysis unit, a provision unit, and a voice assist unit. The recording unit records conversation data. The analysis unit analyzes the conversation data recorded by the recording unit. The provision unit provides an alert based on an analysis result obtained by the analysis unit. The voice assist unit speaks in a friendly voice.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

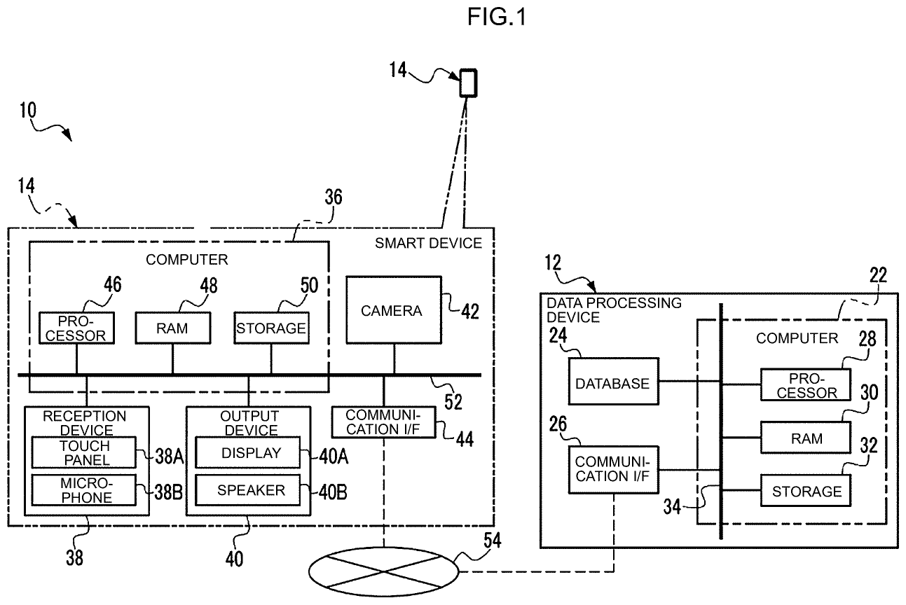

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

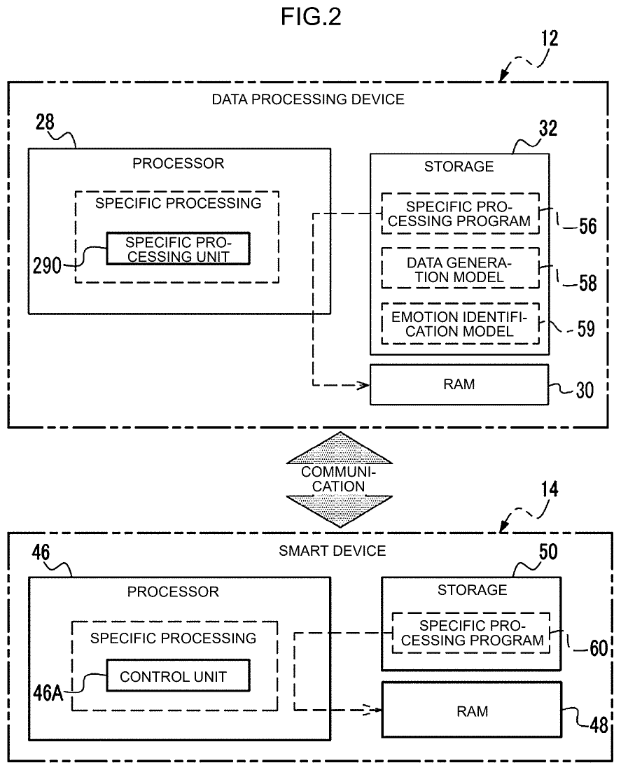

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The health risk reduction system according to the embodiment of the present invention is a system that solves health risks such as dementia and depression, as well as feelings of loneliness faced by elderly people living alone, through AI voice assistance. This health risk reduction system utilizes AI voice assistance to facilitate conversation by speaking in a friendly voice, thereby alleviating feelings of loneliness. Furthermore, it records daily conversations, analyzes increases in grammatical differences, decreases in speaking speed, and performs emotion analysis to diagnose dementia and depression, and provides alerts useful for prevention. For example, the health risk reduction system uses AI voice assistance to speak to the elderly in a friendly voice. For instance, by saying, “Good morning, what plans do you have today?” in a friendly voice, the elderly can feel reassured. As a result, feelings of loneliness are reduced, and daily conversations are expected to increase. Next, the health risk reduction system records daily conversations. The AI voice assist automatically records conversations with the elderly and saves them as data. This data is used for later analysis. For example, it records the content of the conversation, speaking speed, and grammatical differences. Based on the recorded conversation data, the health risk reduction system uses AI to analyze increases in grammatical differences and decreases in speaking speed. For example, if grammar that was previously accurate begins to deteriorate or speaking speed slows down, it may indicate early symptoms of dementia. Additionally, the health risk reduction system performs emotion analysis to detect changes in emotion during conversation. For example, if the person previously spoke in a cheerful voice but has recently been speaking in a depressed tone more often, it may be a sign of depression. Based on these analysis results, the health risk reduction system uses AI to diagnose dementia or depression. For example, if increases in grammatical differences, decreases in speaking speed, or changes in emotion exceed certain thresholds, the AI issues an alert. This alert is notified to the elderly person's family or medical professionals, enabling early intervention. Through this mechanism, the health risk reduction system is expected to reduce health risks and feelings of loneliness faced by elderly people living alone, and contribute to the prevention of dementia and depression. For example, by issuing an alert such as “Recently, your speaking speed has slowed down. Please consult a doctor,” the health risk reduction system enables early diagnosis and treatment. Furthermore, by speaking in a friendly voice, it alleviates the elderly person's loneliness and enriches daily life. Thus, the health risk reduction system can reduce health risks and loneliness faced by elderly people living alone and contribute to the prevention of dementia and depression. Specifically, this health risk reduction system is configured by linking multiple computer modules, such as a speech recognition module, a natural language processing module, an emotion estimation module, an alert generation module, and a speech synthesis module. The system first inputs audio waveform data (e.g., 16 kHz sampling, 16 bit PCM, 1 channel, 10 seconds of audio data) obtained from an acoustic sensor such as a microphone into the speech recognition module. The speech recognition module uses convolutional neural networks (CNN), recurrent neural networks (RNN), or Transformer-based speech recognition models to extract text data (e.g., “The weather is nice today”) from the audio waveform. The extracted text data is input into the natural language processing module, where grammatical analysis (e.g., dependency parsing, part-of-speech tagging), speaking speed analysis (e.g., calculation of words per unit time), and grammatical error detection (e.g., subject-predicate mismatch, misuse of particles) are performed. Furthermore, the emotion estimation module inputs acoustic features extracted from the audio waveform (e.g., F0, formants, energy, spectral envelope) and text features (e.g., frequency of positive/negative words, presence of exclamations) into neural networks such as multilayer perceptrons or LSTM, and outputs emotion labels (e.g., joy, sadness, anger, neutral) and emotion scores (e.g., 0.85/1.0 for “joy”). For example, input examples include utterance audio data such as “I was happy to talk with my friend today” or “Recently, I can't sleep and it's tough.” The AI outputs emotion scores such as “joy: 0.92” or “sadness: 0.81” for these. The output emotion scores, grammatical error rates, and speaking speed data are input into the alert generation module, which determines whether to issue an alert based on threshold judgment rules such as “grammatical error rate increased by 20% compared to the past month's average,” “speaking speed decreased from 120 words per minute to 90 words per minute,” or “emotion score continuously decreasing.” The alert generation module generates alert content (e.g., “Signs of cognitive decline detected,” “Recently, you seem to be feeling down”) and sends it to family members or medical professionals via smartphone apps, email, or voice notification devices. The voice assist unit uses a speech synthesis module (e.g., neural speech synthesis models such as WaveNet or Tacotron) to generate utterances such as “Good morning. What plans do you have today?” in a friendly voice quality (e.g., soft voice of a middle-aged woman, pitch 180 Hz, speed 0.9×), actively encouraging conversation with the user. These series of processes are executed in real time on parallel computing clusters using GPUs or embedded AI processors on edge devices. As a technical effect, this system automates the detection of long-term, high-precision changes in conversation, emotion, and cognitive function, which are difficult to observe subjectively or record and analyze manually, enabling early detection and intervention. Unlike conventional human observation or simple rule-based processing, the integration of high-dimensional feature extraction by neural networks and multimodal (speech, text, emotion) analysis improves the reliability of alerts and reduces false detection rates. Specific application fields include home monitoring for the elderly, remote medical support, health management in care facilities, early detection of mental disorders, and prevention of social isolation for elderly people living alone. Furthermore, the system can integrate and manage data from multiple users in the cloud, enabling personalized alert criteria and conversation styles. Thus, the health risk reduction system possesses high novelty and inventive technical value, contributing not only to the automation of human tasks but also to the improvement of computer technology itself and the resolution of social issues.

The health risk reduction system according to the embodiment comprises a recording unit, an analysis unit, a provision unit, and a voice assist unit. The recording unit records conversation data. The conversation data may include, for example, content of the conversation, speaking speed, and grammatical differences, but is not limited to such examples. The recording unit may automatically record the content of the conversation and save it as data. The recording unit may also measure the speaking speed and save it as data. Furthermore, the recording unit may detect grammatical differences and save them as data. For example, the recording unit may record the content of the conversation and save it as text data. Speaking speed is measured as the number of words per unit time and saved as data. Grammatical differences are detected as types and frequencies of grammatical errors and saved as data. The analysis unit analyzes the conversation data recorded by the recording unit. The analysis unit may analyze, for example, an increase in grammatical differences or a decrease in speaking speed. The analysis unit may also perform emotion analysis and detect changes in emotion during the conversation. For example, the analysis unit measures an increase in grammatical differences as a change in error rate. A decrease in speaking speed is measured as a reduction in the number of words per unit time. Emotion analysis is performed using voice tone or facial expression analysis. The provision unit provides an alert based on the analysis result obtained by the analysis unit. The provision unit may issue an alert based on the analysis result. Alerts may be provided based on notification methods or types of alerts. For example, the provision unit may notify family members or medical professionals of an alert based on the analysis result. Types of alerts may include voice alerts, text alerts, email alerts, and so on. The voice assist unit speaks in a friendly voice. The voice assist unit may adjust the tone, pitch, and speed of the friendly voice. For example, the voice assist unit may speak in a friendly voice, saying “Good morning, what plans do you have today?” As a result, the health risk reduction system according to the embodiment can reduce health risks and feelings of loneliness faced by elderly people living alone and contribute to the prevention of dementia and depression. Some or all of the above-described processing in the provision unit may be performed using AI or without using AI. For example, the provision unit may use an AI model that receives analysis results as input and outputs alerts to provide alerts. Some or all of the above-described processing in the voice assist unit may be performed using AI or without using AI. For example, the voice assist unit may use an AI model that adjusts the tone and pitch of a friendly voice to perform voice assistance. Specifically, this health risk reduction system is configured by linking multiple computer modules, such as a speech recognition module, a natural language processing module, an emotion estimation module, an alert generation module, and a speech synthesis module. The system first inputs audio waveform data (e.g., 16 kHz sampling, 16 bit PCM, 1 channel, 10 seconds of audio data) obtained from an acoustic sensor such as a microphone into the speech recognition module. The speech recognition module uses convolutional neural networks, recurrent neural networks, or Transformer-based speech recognition models to extract text data (e.g., “The weather is nice today”) from the audio waveform. The extracted text data is input into the natural language processing module, where grammatical analysis (e.g., dependency parsing, part-of-speech tagging), speaking speed analysis (e.g., calculation of words per unit time), and grammatical error detection (e.g., subject-predicate mismatch, misuse of particles) are performed. Furthermore, the emotion estimation module inputs acoustic features extracted from the audio waveform (e.g., F0, formants, energy, spectral envelope) and text features (e.g., frequency of positive/negative words, presence of exclamations) into neural networks such as multilayer perceptrons or LSTM, and outputs emotion labels (e.g., joy, sadness, anger, neutral) and emotion scores (e.g., 0.85/1.0 for “joy”). For example, input examples include utterance audio data such as “I was happy to talk with my friend today” or “Recently, I can't sleep and it's tough.” The AI outputs emotion scores such as “joy: 0.92” or “sadness: 0.81” for these. The output emotion scores, grammatical error rates, and speaking speed data are input into the alert generation module, which determines whether to issue an alert based on threshold judgment rules such as “grammatical error rate increased by 20% compared to the past month's average,” “speaking speed decreased from 120 words per minute to 90words per minute,” or “emotion score continuously decreasing.” The alert generation module generates alert content (e.g., “Signs of cognitive decline detected,” “Recently, you seem to be feeling down”) and sends it to family members or medical professionals via smartphone apps, email, or voice notification devices. The voice assist unit uses a speech synthesis module (e.g., neural speech synthesis models such as WaveNet or Tacotron) to generate utterances such as “Good morning. What plans do you have today?” in a friendly voice quality (e.g., soft voice of a middle-aged woman, pitch 180 Hz, speed 0.9×), actively encouraging conversation with the user. These series of processes are executed in real time on parallel computing clusters using GPUs or embedded AI processors on edge devices. As a technical effect, this system automates the detection of long-term, high-precision changes in conversation, emotion, and cognitive function, which are difficult to observe subjectively or record and analyze manually, enabling early detection and intervention. Unlike conventional human observation or simple rule-based processing, the integration of high-dimensional feature extraction by neural networks and multimodal (speech, text, emotion) analysis improves the reliability of alerts and reduces false detection rates. Specific application fields include home monitoring for the elderly, remote medical support, health management in care facilities, early detection of mental disorders, and prevention of social isolation for elderly people living alone. Furthermore, the system can integrate and manage data from multiple users in the cloud, enabling personalized alert criteria and conversation styles. Thus, the health risk reduction system possesses high novelty and inventive technical value, contributing not only to the automation of human tasks but also to the improvement of computer technology itself and the resolution of social issues.

The recording unit can record content of the conversation, speaking speed, or grammatical differences. The recording unit may automatically record the content of the conversation and save it as data. The content of the conversation may include, for example, daily conversations or conversations related to medical care, but is not limited to such examples. The recording unit may also measure the speaking speed and save it as data. Speaking speed may be measured as the number of words per unit time. Furthermore, the recording unit may detect grammatical differences and save them as data. Grammatical differences may be detected as types and frequencies of grammatical errors. By recording detailed conversation data in this manner, the accuracy of analysis is improved. Some or all of the above-described processing in the recording unit may be performed using AI or without using AI. For example, the recording unit may use an AI model that records the content of the conversation by recording and saving it as text data. Specifically, the recording unit receives audio waveform data (e.g., 16 kHz sampling, 16 bit PCM, 1 channel, 10 seconds of audio data) obtained from an acoustic sensor as input. The recording unit uses neural networks such as convolutional neural networks, recurrent neural networks, or Transformer-based speech recognition models to extract text data (e.g., “I went to the hospital today” or “I forgot to take my medicine”) from the audio waveform. The extracted text data is saved as structured data such as JSON format or time-series databases. For measuring speaking speed, the recording unit calculates the number of words or syllables per unit time from the speech recognition results and records specific values such as 120 words, 90 words, or 60 words per minute. For detecting grammatical differences, the recording unit uses a natural language processing module to perform dependency parsing and part-of-speech tagging, counts grammatical errors such as subject-predicate mismatch, misuse of particles, or word order disorder by type, and records error frequency (e.g., 3 errors or 5 errors per conversation). When using an AI model, the recording unit inputs audio waveform data or text data and obtains multidimensional vectors such as text strings, speaking speed scores, and grammatical error labels as output from the speech recognition model. For example, when inputting audio data such as “I was happy to talk with my friend today,” the recording unit generates outputs such as “Text: I was happy to talk with my friend today,” “Speaking speed: 110 words/min,” and “Grammatical errors: 0.” These recorded data serve as high-precision basic data for subsequent detection of changes in cognitive function or emotion by the analysis unit. As a technical effect, the recording unit realizes automatic collection of long-term, high-frequency, and high-precision conversation data, which is difficult to achieve by manual recording, and greatly improves the comprehensiveness and reliability of the data. Unlike conventional simple recording or handwritten records, multilayered extraction of speech, text, and grammatical information by neural networks contributes to improved accuracy of subsequent AI analysis and reduction of false detection rates. Specific application fields include home monitoring for the elderly, remote medical support, health management in care facilities, early detection of mental disorders, and prevention of social isolation for elderly people living alone. Furthermore, the recording unit can integrate and manage data from multiple users in the cloud, enabling personalization of optimized recording frequency and recording items. Thus, the recording unit possesses high novelty and inventive technical value, contributing not only to the automation of human tasks but also to the improvement of computer technology itself and the resolution of social issues.

The analysis unit can analyze an increase in grammatical differences or a decrease in speaking speed. The analysis unit may measure an increase in grammatical differences as a change in error rate. An increase in grammatical differences may be measured as a change in the types or frequency of grammatical errors. The analysis unit may also measure a decrease in speaking speed as a reduction in the number of words per unit time. A decrease in speaking speed may be measured as a change in speaking speed. By analyzing changes in grammatical differences or speaking speed, early symptoms of dementia can be detected. Some or all of the above-described processing in the analysis unit may be performed using AI or without using AI. For example, the analysis unit may use an AI model that receives increases in grammatical differences or decreases in speaking speed as input and detects early symptoms of dementia. Specifically, the analysis unit receives multidimensional vectors such as text data, speaking speed data, and grammatical error labels from the recording unit as input. The analysis unit uses time-series analysis algorithms (e.g., moving average, autoregressive models, LSTM recurrent neural networks) to analyze trends in grammatical error rates and speaking speed over the past month or three months. For example, input examples include time-series data such as “Grammatical error rate over the past 30 days: 1.2%→2.5%→3.8%” and “Speaking speed: 120 words/min→110 words/min→90 words/min.” The analysis unit extracts these changes as features and applies threshold judgment (e.g., grammatical error rate increased by more than 20% compared to the past average, speaking speed decreased by more than 10%) or anomaly detection models (e.g., Isolation Forest, One-Class SVM) to detect signs of cognitive decline. When using an AI model, the analysis unit inputs time-series vectors of grammatical error rates and speaking speed and outputs scores or labels such as “Dementia risk score: 0.78” or “Anomaly detection label: 1 (anomaly).” For example, when inputting “Grammatical error rate: 3.5%, speaking speed: 85 words/min,” the analysis unit obtains outputs such as “Dementia risk score: 0.82” and “Alert required: 1.” These outputs are used for subsequent alert generation or notification to medical professionals. As a technical effect, the analysis unit realizes high-precision automatic detection of subtle changes in cognitive function over long periods, which is difficult with subjective human observation or simple rule-based processing. The combination of high-dimensional feature extraction by neural networks and time-series anomaly detection enables reduction of false detection rates and improvement of reliability in early detection. Specific application fields include early detection of dementia in the elderly, remote medical support, health management in care facilities, and monitoring of mental disorders. Furthermore, the analysis unit can integrate and analyze data from multiple users, enabling personalized anomaly judgment criteria and risk evaluation. Thus, the analysis unit possesses high novelty and inventive technical value, contributing not only to the automation of human tasks but also to the improvement of computer technology itself and the resolution of social issues.

The analysis unit can perform emotion analysis and detect changes in emotion during conversation. The analysis unit may, for example, perform emotion analysis and detect changes in emotion during conversation. Emotion analysis may be performed using voice tone or facial expression analysis. Changes in emotion may be detected as fluctuations in emotion scores. By detecting changes in emotion, signs of depression can be discovered early. Emotion estimation may be realized using emotion engines or generative AI, such as text generation AI (e.g., LLM) or multimodal generative AI, but is not limited to such examples. Some or all of the above-described processing in the analysis unit may be performed using AI or without using AI. For example, the analysis unit may input voice tone or facial expression data into generative AI to detect changes in emotion. Specifically, the analysis unit inputs acoustic features extracted from audio waveform data (e.g., fundamental frequency F0, formants, energy, spectral envelope), facial expression features extracted from camera images (e.g., degree of mouth corner lift, eyebrow movement, eye opening/closing), and text features (e.g., frequency of positive/negative words, presence of exclamations) into neural networks such as multilayer perceptrons, LSTM, or Transformer. Input examples include utterance audio data such as “I was happy to talk with my friend today,” “Recently, I can't sleep and it's tough,” or facial expression images such as “smiling face” or “expressionless face.” The analysis unit integrates these features and generates outputs such as emotion labels (e.g., joy, sadness, anger, neutral) and emotion scores (e.g., joy 0.92, sadness 0.81). The analysis unit analyzes time-series fluctuations in emotion scores (e.g., joy score decreased from 0.85 to 0.60 to 0.40 over the past week) and, if a certain threshold (e.g., below 0.5 for more than three days) is exceeded, determines “high risk of depression.” AI models may include Transformer-based emotion estimation models that accept multimodal inputs of voice, image, and text, or LSTM-based time-series emotion change models. Output examples include “Emotion label: sadness,” “Emotion score: 0.78,” and “Anomaly detection label: 1 (anomaly).” These outputs are used for subsequent alert generation or notification to medical professionals. As a technical effect, the analysis unit realizes automatic detection of long-term, high-frequency, and high-precision emotion changes, which is difficult with subjective human observation or simple questionnaires, enabling early detection and intervention for mental disorders such as depression. The combination of high-dimensional feature extraction by neural networks and multimodal integrated analysis enables reduction of false detection rates and improvement of reliability in emotion estimation. Specific application fields include monitoring of mental disorders in the elderly, remote medical support, psychological care in care facilities, and prevention of social isolation for elderly people living alone. Furthermore, the analysis unit can integrate and analyze emotion data from multiple users, enabling personalized emotion judgment criteria and psychological care. Thus, the analysis unit possesses high novelty and inventive technical value, contributing not only to the automation of human tasks but also to the improvement of computer technology itself and the resolution of social issues.

The provision unit can issue an alert based on the analysis result. The provision unit may, for example, issue an alert based on the analysis result. Alerts may be provided based on notification methods or types of alerts. Alert content may include, for example, information about health risks or information encouraging medical consultation, but is not limited to such examples. For example, the provision unit may notify family members or medical professionals of an alert based on the analysis result. Types of alerts may include voice alerts, text alerts, email alerts, and so on. By issuing alerts based on analysis results, early intervention is possible. Some or all of the above-described processing in the provision unit may be performed using AI or without using AI. For example, the provision unit may use an AI model that receives analysis results as input and outputs alerts to provide alerts. Specifically, the provision unit receives multidimensional vector analysis result data (e.g., grammatical error rate 0.12, speaking speed 85 words/min, emotion score “sadness” 0.81, dementia risk score 0.78) from the analysis unit as input. The provision unit passes these input data to the alert generation module, applies threshold judgment algorithms (e.g., grammatical error rate increased by more than 20% compared to the past month's average, emotion score below 0.5 for more than three days) or anomaly detection models (e.g., Isolation Forest, One-Class SVM), and determines whether to issue an alert. When using an AI model, the provision unit inputs the analysis result vector and outputs alert labels (e.g., “Caution,” “Consultation required,” “Follow-up observation”), alert content text (e.g., “Signs of cognitive decline detected,” “Recently, you seem to be feeling down”), and notification recipients (e.g., family, medical professionals, the user). For example, when inputting “Grammatical error rate: 3.5%, speaking speed: 85 words/min, emotion score: 0.42,” the AI model generates outputs such as “Alert label: Consultation required,” “Alert content: Signs of cognitive decline detected,” and “Notification recipients: family and medical professionals.” The output alert content is passed to the speech synthesis module or text notification module and provided in formats such as voice alerts (e.g., “Recently, your speaking speed has slowed down. Please consult a doctor” generated by WaveNet), text alerts (e.g., notifications to smartphone apps), or email alerts (e.g., automatic email to family). These alerts are delivered in real time to the user's device or to family and medical professionals' devices. As a technical effect, the provision unit automates high-precision and highly immediate alert issuance that integrates analysis results from multiple modalities, which is difficult with subjective human judgment or manual notification, enabling early detection and intervention. Unlike conventional simple rule-based notifications or manual contact, the combination of high-dimensional feature integration by neural networks and threshold judgment/anomaly detection improves the reliability of alerts and reduces false notification rates. Specific application fields include home monitoring for the elderly, remote medical support, health management in care facilities, early detection of mental disorders, and prevention of social isolation for elderly people living alone. Furthermore, the provision unit can integrate and manage alert histories from multiple users in the cloud, enabling personalized alert criteria and notification methods. Thus, the provision unit possesses high novelty and inventive technical value, contributing not only to the automation of human tasks but also to the improvement of computer technology itself and the resolution of social issues.

The voice assist unit can speak in a friendly voice. The voice assist unit may adjust the tone, pitch, and speed of the friendly voice. Characteristics of a friendly voice may include, for example, a gentle tone, moderate pitch, and slow speed, but are not limited to such examples. For example, the voice assist unit may speak in a friendly voice, saying “Good morning, what plans do you have today?” By speaking in a friendly voice, the loneliness of elderly people can be alleviated. Some or all of the above-described processing in the voice assist unit may be performed using AI or without using AI. For example, the voice assist unit may use an AI model that adjusts the tone and pitch of a friendly voice to perform voice assistance. Specifically, the voice assist unit receives acoustic parameters for generating a friendly voice quality (e.g., pitch 180 Hz, speed 0.9×, formant enhancement, spectral envelope adjustment) as input using a speech synthesis module (e.g., neural speech synthesis models such as WaveNet or Tacotron). The voice assist unit determines optimal voice quality parameters based on user attributes (e.g., age, gender, past conversation history) and emotion estimation results (e.g., relaxation 0.85, stress 0.12), and inputs them into the speech synthesis model. Input examples include “Text: Good morning. What plans do you have today?” “Voice quality parameters: middle-aged female, pitch 180 Hz, speed 0.9×,emotion label: sense of security.” The speech synthesis model outputs high-quality audio waveform data (e.g., 16 kHz sampling, 16 bit PCM, 10 seconds of audio data) from these inputs. Output examples include “Audio waveform data: friendly female voice,” “Audio features: F0=180 Hz, speed=0.9×.” The generated audio is played from the user's device speaker, promoting natural dialogue with the user. In subsequent processing, the user's response audio is acquired again by the recording unit and used for analysis of conversation history and emotional changes. As a technical effect, the voice assist unit realizes individually optimized friendly voice generation by controlling high-dimensional acoustic features and integrating user attributes and emotion information using neural networks, which is different from conventional simple voice playback or reading of fixed phrases. This enables reduction of loneliness, promotion of conversation, and improvement of psychological comfort for users. Specific application fields include home monitoring for the elderly, remote medical support, psychological care in care facilities, and prevention of social isolation for elderly people living alone. Furthermore, the voice assist unit can integrate and manage voice quality preferences and conversation histories from multiple users in the cloud, enabling automatic optimization of personalized voice styles. Thus, the voice assist unit possesses high novelty and inventive technical value, contributing not only to the automation of human tasks but also to the improvement of computer technology itself and the resolution of social issues.

The recording unit can estimate a user's emotion and adjust the frequency of conversation recording based on the estimated emotion of the user. For example, if the user is feeling stressed, the recording unit reduces the frequency of conversation recording to alleviate the burden. If the user is relaxed, the recording unit may increase the frequency of conversation recording to collect more detailed data. Furthermore, if the user is in a hurry, the recording unit may record only important conversations to efficiently collect data. By adjusting the frequency of conversation recording according to the user's emotion, the burden can be reduced. Emotion estimation may be realized using emotion engines or generative AI, such as text generation AI (e.g., LLM) or multimodal generative AI, but is not limited to such examples. Some or all of the above-described processing in the recording unit may be performed using AI or without using AI. For example, the recording unit may input the user's emotion data into generative AI and adjust the recording frequency based on the emotion. Specifically, the recording unit inputs the user's audio waveform data (e.g., 16 kHz sampling, 16 bit PCM, 10 seconds of audio data), facial image data (e.g., 30 fps, 640×480 pixels), and text data (e.g., “I'm tired today”) into the emotion estimation module. The recording unit uses multimodal emotion estimation models based on convolutional neural networks, LSTM, or Transformer to integrate acoustic features (e.g., F0, energy), facial features (e.g., degree of mouth corner lift), and text features (e.g., frequency of negative words), and outputs emotion labels (e.g., stress, relaxation, hurry) and emotion scores (e.g., stress 0.82, relaxation 0.15). Input examples include “Speech: utterance with sigh,” “Facial expression: furrowed brow,” “Text: I'm busy today.” The AI model outputs scores such as “Stress: 0.85,” “Hurry: 0.70.” The recording unit uses these emotion scores for threshold judgment (e.g., stress score 0.8 or higher reduces recording frequency to one-third, relaxation 0.7 or higher increases recording frequency twofold) and dynamically controls the recording scheduler. For example, in a stress state, recording is performed only once per day; in a relaxation state, recording is performed three times per day; in a hurry, only utterances flagged as “important conversation” are recorded. Output examples include “Recording frequency: once per day,” “Recording target: important conversations only.” These control parameters are reflected in subsequent database recording processing and data supply to the analysis unit. As a technical effect, the recording unit minimizes the user's psychological burden and privacy concerns while efficiently and accurately collecting sufficient data. Unlike conventional uniform recording methods or manual control by humans, the combination of real-time emotion estimation by AI and recording frequency optimization algorithms achieves both comprehensiveness of data and user experience. Specific application fields include home monitoring for the elderly, mental disorder monitoring, remote medical support, and stress management in care facilities. Furthermore, the recording unit can integrate and manage emotion and recording histories from multiple users in the cloud, enabling personalized optimization of recording frequency and recording targets. Thus, the recording unit possesses high novelty and inventive technical value, contributing not only to the automation of human tasks but also to the improvement of computer technology itself and the resolution of social issues.

The recording unit can analyze a user's past conversation history and select an appropriate recording method. For example, the recording unit may prioritize recording topics that the user has frequently discussed in the past. The recording unit may also concentrate recording during specific time periods based on the user's past conversation history. Furthermore, the recording unit may analyze the user's past conversation patterns and propose optimal recording methods. By analyzing past conversation history, the optimal recording method can be selected. Some or all of the above-described processing in the recording unit may be performed using AI or without using AI. For example, the recording unit may input the user's past conversation data into generative AI and select the optimal recording method. Specifically, the recording unit receives multidimensional data such as conversation text data accumulated chronologically for each user (e.g., 10 entries per day, each about 100 characters), conversation topic labels (e.g., health, family, hobbies), and conversation occurrence times (e.g., 7 a.m., 8 p.m.) as input. The recording unit uses natural language processing modules (e.g., BERT-based topic classification models), time-series clustering algorithms (e.g., K-means, DBSCAN), and frequency analysis algorithms (e.g., Apriori method) to extract distributions of past conversation topics and patterns of utterance frequency. Input examples include “Distribution of conversation topics over the past 30 days: health 40%, family 30%, hobbies 20%, others 10%” and “Distribution of utterance times: 30% at 7 a.m., 50% at 8 p.m.” The AI model outputs recording policies such as “Priority recording topics: health and family” and “Concentrated recording time: 8 p.m.” Furthermore, conversation patterns (e.g., continuous utterances, single utterances, question-answer type) are analyzed using time-series models such as LSTM or Transformer, and optimal recording methods such as “Record all entries for continuous utterances, record only summaries for single utterances” are proposed. Output examples include “Recording target: health and family topics,” “Recording time: 8 p.m. ,” “Recording method: full text for continuous utterances, summary for single utterances.” These recording policies are reflected in the recording scheduler and database recording processing. As a technical effect, the recording unit automatically selects recording methods optimized for each user's conversation tendencies and lifestyle rhythms, improving the usefulness and comprehensiveness of data while minimizing recording load and storage consumption. Unlike conventional uniform recording or manual selection by humans, the combination of pattern extraction and optimization algorithms by AI achieves both recording efficiency and analysis accuracy. Specific application fields include monitoring of elderly people's daily life, analysis of conversation patterns in mental disorders, remote medical support, and efficiency improvement of recording operations in care facilities. Furthermore, the recording unit can integrate and manage conversation histories from multiple users in the cloud, enabling personalized optimization of recording policies. Thus, the recording unit possesses high novelty and inventive technical value, contributing not only to the automation of human tasks but also to the improvement of computer technology itself and the resolution of social issues.

The recording unit can perform filtering during conversation recording based on the user's current health status or living conditions. For example, if the user is in poor physical condition, the recording unit records only important conversations to reduce the burden. The recording unit may also adjust the content of recorded conversations according to the user's living conditions. Furthermore, the recording unit may determine the priority of recorded conversations based on the user's health status. By performing filtering based on health status or living conditions, the burden can be reduced. Some or all of the above-described processing in the recording unit may be performed using AI or without using AI. For example, the recording unit may input the user's health data into generative AI to perform filtering. Specifically, the recording unit receives the user's health status data (e.g., body temperature, blood pressure, heart rate, self-reported health score), living condition data (e.g., status such as at home, out, or visiting hospital), and conversation text data (e.g., “I have a headache today”) as input. The recording unit uses health status judgment modules (e.g., anomaly detection models using random forest or LSTM) and living condition classification models (e.g., SVM or Transformer-based classifiers) to classify the user's status as “poor health,” “normal,” or “busy.” Input examples include “Body temperature: 37.8° C.,” “Heart rate: 95 bpm,” “Living condition: visiting hospital,” “Conversation: I went to the hospital today.” The AI model outputs labels such as “Poor health: 1,” “Important conversation: 1.” The recording unit applies filtering policies such as “Record only medical/health-related conversations during poor health,” “Record all conversations during normal status,” and “Record summaries during busy status” based on these labels. Output examples include “Recording target: medical-related conversations,” “Recording method: summary.” These filtering results are reflected in the recording database and subsequent data supply to the analysis unit. As a technical effect, the recording unit realizes flexible recording control according to the user's health status and living conditions, minimizing unnecessary data recording and user burden while enabling comprehensive collection of important information. Unlike conventional uniform recording or manual selection by humans, the combination of real-time status judgment and filtering algorithms by AI achieves both recording efficiency and analysis accuracy. Specific application fields include health monitoring for the elderly, life recording for chronic disease patients, remote medical support, and efficiency improvement of recording operations in care facilities. Furthermore, the recording unit can integrate and manage health and living data from multiple users in the cloud, enabling personalized optimization of recording policies. Thus, the recording unit possesses high novelty and inventive technical value, contributing not only to the automation of human tasks but also to the improvement of computer technology itself and the resolution of social issues.

The recording unit can estimate a user's emotion and determine the priority of conversations to be recorded based on the estimated emotion of the user. For example, if the user is feeling stressed, the recording unit prioritizes recording important conversations. If the user is relaxed, the recording unit may record all conversations equally. Furthermore, if the user is in a hurry, the recording unit may prioritize recording short conversations containing important information. By determining the priority of conversations to be recorded based on emotion, important conversations can be recorded preferentially. Emotion estimation may be realized using emotion engines or generative AI, such as text generation AI (e.g., LLM) or multimodal generative AI, but is not limited to such examples. Some or all of the above-described processing in the recording unit may be performed using AI or without using AI. For example, the recording unit may input the user's emotion data into generative AI and determine the priority of conversations to be recorded based on emotion. Specifically, the recording unit inputs the user's audio waveform data, facial image data, and text data into the emotion estimation module, and uses multimodal emotion estimation models based on convolutional neural networks, LSTM, or Transformer to output emotion labels (e.g., stress, relaxation, hurry) and emotion scores (e.g., stress 0.80, relaxation 0.10). Input examples include “Speech: fast and tense utterance,” “Facial expression: furrowed brow,” “Text: I'm in a hurry.” The AI model outputs scores such as “Hurry: 0.85,” “Stress: 0.75.” The recording unit uses these emotion scores for threshold judgment (e.g., stress score 0.7 or higher records only medical/health-related conversations, relaxation 0.7 or higher records all conversations, hurry 0.7 or higher records only short and important conversations) and dynamically controls the priority of recording targets. For example, in a stress state, “Medical and family-related conversations are prioritized”; in a relaxation state, “All conversations are recorded equally”; in a hurry, “Summary recording” is applied. Output examples include “Recording priority: medical>family>others,” “Recording method: summary.” These priorities are reflected in the recording database and subsequent data supply to the analysis unit. As a technical effect, the recording unit minimizes the user's psychological burden and privacy concerns while efficiently and accurately collecting important information. Unlike conventional uniform recording or manual selection by humans, the combination of real-time emotion estimation by AI and recording priority optimization algorithms achieves both recording efficiency and analysis accuracy. Specific application fields include home monitoring for the elderly, mental disorder monitoring, remote medical support, and efficiency improvement of recording operations in care facilities. Furthermore, the recording unit can integrate and manage emotion and recording histories from multiple users in the cloud, enabling personalized optimization of recording priorities. Thus, the recording unit possesses high novelty and inventive technical value, contributing not only to the automation of human tasks but also to the improvement of computer technology itself and the resolution of social issues.

The recording unit can consider the user's geographic location information during conversation recording and preferentially record highly relevant conversations. For example, if the user is in a specific location, the recording unit prioritizes recording conversations related to that location. The recording unit may also select important conversations based on the user's geographic location information. Furthermore, if the user is moving, the recording unit may prioritize recording conversations related to the destination. By preferentially recording highly relevant conversations based on geographic location information, data can be collected efficiently. Some or all of the above-described processing in the recording unit may be performed using AI or without using AI. For example, the recording unit may input the user's geographic location information into generative AI and select highly relevant conversations. Specifically, the recording unit receives geographic location data obtained from the user's device GPS sensor (e.g., latitude/longitude, location label such as “home,” “hospital,” “park”), conversation text data (e.g., “I had a medical test at the hospital today”), and movement history data (e.g., movement route over the past 24 hours) as input. The recording unit uses geographic information analysis modules (e.g., map API integration, location clustering algorithms) and natural language processing modules (e.g., BERT-based topic classification models) to calculate relevance scores between conversation content and location (e.g., health-related conversation score 0.95 at hospital, exercise-related conversation score 0.88 at park). Input examples include “Location: hospital,” “Conversation: I'm worried about the test results,” “In transit: home→hospital.” The AI model outputs “Relevance score: 0.92,” “Priority recording: health-related conversation.” The recording unit dynamically controls recording targets for each location based on these scores. For example, at hospitals, “Health/medical-related conversations are prioritized”; at parks, “Exercise/social-related conversations are prioritized”; in transit, “Conversations related to the destination are prioritized.” Output examples include “Recording target: health-related conversation,” “Recording priority: location-related>others.” These recording policies are reflected in the recording database and subsequent data supply to the analysis unit. As a technical effect, the recording unit realizes efficient collection of highly relevant data according to the user's behavioral context and living environment, contributing to improved analysis accuracy and alert reliability. Unlike conventional uniform recording or manual selection by humans, the combination of geographic information and conversation content integrated analysis and recording optimization algorithms by AI achieves both recording efficiency and data usefulness. Specific application fields include health monitoring for elderly people during outings, medical record management for patients visiting hospitals, and optimization of behavioral recording in care facilities. Furthermore, the recording unit can integrate and manage geographic information and conversation histories from multiple users in the cloud, enabling personalized optimization of recording policies. Thus, the recording unit possesses high novelty and inventive technical value, contributing not only to the automation of human tasks but also to the improvement of computer technology itself and the resolution of social issues.

The recording unit can analyze the user's social media activity during conversation recording and record relevant conversations. For example, the recording unit may prioritize recording topics that the user is discussing on social media. The recording unit may also select important conversations based on the user's social media activity. Furthermore, the recording unit may adjust the content of recorded conversations based on the user's social media activity. By analyzing social media activity, relevant conversations can be recorded efficiently. Some or all of the above-described processing in the recording unit may be performed using AI or without using AI. For example, the recording unit may input the user's social media data into generative AI and record relevant conversations. Specifically, the recording unit receives the user's social media post data (e.g., text posts, image posts, posting time, topic labels), conversation text data (e.g., “I talked with my friend on SNS today”), and posting frequency data (e.g., 5 posts per day, 30 posts per week) as input. The recording unit uses natural language processing modules (e.g., BERT-based topic classification models), image analysis modules (e.g., CNN for image content classification), and posting frequency analysis algorithms to calculate relevance scores between social media activity and conversation content (e.g., match score 0.90 between health topic discussed on SNS and conversation content). Input examples include “SNS post: about health checkup,” “Conversation: I'm concerned about the test results.” The AI model outputs “Relevance score: 0.88,” “Priority recording: health-related conversation.” The recording unit prioritizes recording conversations related to topics discussed on SNS and extracts highly important conversations based on these scores. Output examples include “Recording target: SNS-related topic conversation,” “Recording priority: SNS-related >others.” These recording policies are reflected in the recording database and subsequent data supply to the analysis unit. As a technical effect, the recording unit realizes efficient collection of highly relevant data according to the user's social interests and information dissemination tendencies, contributing to improved analysis accuracy and alert reliability. Unlike conventional uniform recording or manual selection by humans, the combination of social media and conversation content integrated analysis and recording optimization algorithms by AI achieves both recording efficiency and data usefulness. Specific application fields include monitoring of social interactions for the elderly, analysis of information dissemination in mental disorder patients, and efficiency improvement of recording operations in care facilities. Furthermore, the recording unit can integrate and manage SNS activity and conversation histories from multiple users in the cloud, enabling personalized optimization of recording policies. Thus, the recording unit possesses high novelty and inventive technical value, contributing not only to the automation of human tasks but also to the improvement of computer technology itself and the resolution of social issues.

The analysis unit can estimate a user's emotion and adjust the accuracy of analysis based on the estimated emotion of the user. For example, if the user is feeling stressed, the analysis unit increases the accuracy of analysis to provide detailed results. If the user is relaxed, the analysis unit may adjust the accuracy to provide balanced results. Furthermore, if the user is in a hurry, the analysis unit may perform rapid analysis and provide concise results. By adjusting the accuracy of analysis based on emotion, detailed results can be provided. Emotion estimation may be realized using emotion engines or generative AI, such as text generation AI (e.g., LLM) or multimodal generative AI, but is not limited to such examples. Some or all of the above-described processing in the analysis unit may be performed using AI or without using AI. For example, the analysis unit may input the user's emotion data into generative AI and adjust the accuracy of analysis based on emotion. Specifically, the analysis unit inputs the user's audio waveform data (e.g., 16 kHz sampling, 16 bit PCM, 10 seconds of audio), facial image data (e.g., 30 fps, 640×480 pixels), and text data (e.g., “I'm tired today”) into the emotion estimation module. The analysis unit uses multimodal emotion estimation models based on convolutional neural networks, LSTM, or Transformer to integrate acoustic features (e.g., F0, energy), facial features (e.g., degree of mouth corner lift), and text features (e.g., frequency of negative words), and outputs emotion labels (e.g., stress, relaxation, hurry) and emotion scores (e.g., stress 0.82, relaxation 0.15). Input examples include “Speech: utterance with sigh,” “Facial expression: furrowed brow,” “Text: I'm busy today.” The AI model outputs scores such as “Stress: 0.85,” “Hurry: 0.70.” The analysis unit uses these emotion scores for threshold judgment (e.g., stress score 0.8 or higher for high-accuracy analysis, relaxation 0.7 or higher for standard-accuracy analysis, hurry 0.7 or higher for simplified analysis) and dynamically controls analysis algorithm parameters (e.g., window size, number of features, model depth). For example, in a stress state, the number of LSTM layers is increased for detailed time-series analysis; in a relaxation state, feature selection is simplified for balanced analysis; in a hurry, only moving averages or simple threshold judgments are used for rapid results. Output examples include “Analysis accuracy: high,” “Analysis result: detailed report,” “Analysis time: 5 seconds,” or “Analysis accuracy: standard,” “Analysis result: summary report,” “Analysis time: 2 seconds.” These analysis results are used for subsequent alert generation or notification to the user's device. As a technical effect, the analysis unit automatically adjusts optimal analysis accuracy and speed according to the user's psychological state and usage situation, achieving both improved user experience and efficient use of system resources. Unlike conventional uniform analysis or manual settings by humans, the combination of real-time emotion estimation by AI and analysis parameter optimization algorithms enables dynamic control of accuracy, speed, and load, reducing false detection rates and improving user satisfaction. Specific application fields include home monitoring for the elderly, mental disorder monitoring, remote medical support, and health management in care facilities. Furthermore, the analysis unit can integrate and manage emotion and analysis histories from multiple users in the cloud, enabling personalized optimization of analysis accuracy and policies. Thus, the analysis unit possesses high novelty and inventive technical value, contributing not only to the automation of human tasks but also to the improvement of computer technology itself and the resolution of social issues.

The analysis unit can apply different analysis algorithms during analysis based on the content of the conversation. For example, if the content of the conversation is related to health, the analysis unit applies health-related analysis algorithms. If the content of the conversation is related to daily life, the analysis unit may apply daily life-related analysis algorithms. Furthermore, if the content of the conversation is related to emotion, the analysis unit may apply emotion analysis algorithms. By applying appropriate analysis algorithms based on the content of the conversation, the accuracy of analysis is improved. Some or all of the above-described processing in the analysis unit may be performed using AI or without using AI. For example, the analysis unit may input conversation content data into generative AI and apply appropriate analysis algorithms. Specifically, the analysis unit inputs conversation text data (e.g., “I went to the hospital today,” “Recently, I can't sleep and it's tough”) received from the recording unit into a natural language processing module. The analysis unit uses topic classification models based on BERT or Transformer to automatically classify conversation content into categories such as “health,” “daily life,” “emotion,” or “hobbies.” Input examples include “Conversation: I'm worried about my high blood pressure,” “Conversation: I went to the park with my friend today,” “Conversation: Recently, I'm feeling down.” The AI model outputs labels such as “Category: health,” “Category: daily life,” “Category: emotion.” The analysis unit automatically selects different analysis algorithms for each category (e.g., time-series health risk estimation model for health category, life rhythm analysis model for daily life category, emotion estimation model for emotion category) and executes optimal feature extraction and analysis processing. For example, in the health category, cross-analysis with heart rate or blood pressure data is performed; in the daily life category, correlation analysis with activity level or frequency of social interaction is performed; in the emotion category, multimodal emotion estimation using speech, facial expression, and text is performed. Output examples include “Health risk score: 0.78,” “Life rhythm abnormality: none,” “Emotion score: sadness 0.81.” These analysis results are used for subsequent alert generation or notification to the user's device. As a technical effect, the analysis unit greatly improves analysis accuracy, reliability, and interpretability by selecting optimal algorithms according to conversation content. Unlike conventional uniform processing or manual selection by humans, the combination of automatic topic classification and algorithm switching control by AI reduces false detection rates and enables flexible response to diverse health risks and life issues. Specific application fields include health management for the elderly, life rhythm monitoring, emotion analysis for mental disorders, and multipurpose conversation analysis in care facilities. Furthermore, the analysis unit can integrate and manage conversation content and analysis histories from multiple users in the cloud, enabling personalized optimization of algorithm selection and analysis policies. Thus, the analysis unit possesses high novelty and inventive technical value, contributing not only to the automation of human tasks but also to the improvement of computer technology itself and the resolution of social issues.

The analysis unit can refer to the user's past health data during analysis to improve the reliability of the analysis result. For example, the analysis unit may analyze the user's current health status based on past health data. The analysis unit may also refer to past health data to improve the accuracy of analysis results. Furthermore, the analysis unit may utilize past health data to enhance the reliability of analysis results. By referring to past health data, the reliability of analysis results is improved. Some or all of the above-described processing in the analysis unit may be performed using AI or without using AI. For example, the analysis unit may input the user's past health data into generative AI to improve the reliability of analysis results. Specifically, the analysis unit receives time-series health data accumulated for each user (e.g., numerical vectors of body temperature, blood pressure, heart rate, sleep duration, activity level over the past year) and conversation data (e.g., health-related utterances) as input. The analysis unit uses time-series analysis models such as LSTM or Transformer to extract trends and variation patterns in past health indicators and analyzes correlations with current conversation content and health status. Input examples include “Blood pressure over the past 30 days: 120/80→130/85→140/90,” “Sleep duration: 7.5 h→6.0 h→5.0 h,” “Conversation: Recently, I can't sleep and it's tough.” The AI model integrates these time-series data and conversation content to generate outputs such as “Health risk score: 0.82,” “Reliability: high.” The analysis unit applies deviation from past data and anomaly detection algorithms (e.g., Isolation Forest, One-Class SVM) to assign reliability indicators (e.g., reliability score 0.95, anomaly detection label 1) to the analysis results. Output examples include “Analysis result: caution required,” “Reliability: 0.93,” “Deviation from past data: +15%.” These reliability indicators are used for subsequent alert generation or notification to medical professionals. As a technical effect, the analysis unit greatly improves analysis accuracy, reliability, and early detection capability by utilizing individual health histories for personalized optimization analysis. Unlike conventional simple current value judgment or subjective evaluation by humans, the combination of time-series history analysis and anomaly detection algorithms by AI reduces false detection rates and improves reliability. Specific application fields include chronic disease management for the elderly, risk assessment for lifestyle-related diseases, long-term monitoring of mental disorders, and health management in care facilities. Furthermore, the analysis unit can integrate and manage health histories and analysis results from multiple users in the cloud, enabling personalized optimization of reliability evaluation and analysis policies. Thus, the analysis unit possesses high novelty and inventive technical value, contributing not only to the automation of human tasks but also to the improvement of computer technology itself and the resolution of social issues.

The analysis unit can estimate a user's emotion and adjust the display method of the analysis result based on the estimated emotion of the user. For example, if the user is nervous, the analysis unit provides a simple and highly visible display method. If the user is relaxed, the analysis unit may provide a display method that includes detailed information. Furthermore, if the user is in a hurry, the analysis unit may provide a display method that highlights key points. By adjusting the display method based on emotion, highly visible results can be provided. Emotion estimation may be realized using emotion engines or generative AI, such as text generation AI (e.g., LLM) or multimodal generative AI, but is not limited to such examples. Some or all of the above-described processing in the analysis unit may be performed using AI or without using AI. For example, the analysis unit may input the user's emotion data into generative AI and adjust the display method based on emotion. Specifically, the analysis unit inputs the user's audio waveform data, facial image data, and text data into the emotion estimation module, and uses multimodal emotion estimation models based on convolutional neural networks, LSTM, or Transformer to output emotion labels (e.g., nervousness, relaxation, hurry) and emotion scores (e.g., nervousness 0.80, relaxation 0.10). Input examples include “Speech: fast and nervous utterance,” “Facial expression: eyes wide open,” “Text: I'm worried.” The AI model outputs scores such as “Nervousness: 0.85,” “Relaxation: 0.12.” The analysis unit uses these emotion scores for threshold judgment (e.g., nervousness score 0.7 or higher for simple display, relaxation 0.7 or higher for detailed display, hurry 0.7 or higher for summary display) and dynamically controls display module parameters (e.g., number of display items, font size, color coding, presence of graphs). For example, in a nervous state, “Display only key points in large font”; in a relaxation state, “Display detailed graphs and annotations”; in a hurry, “Display only summary.” Output examples include “Display format: simple,” “Number of display items: 3,” “Graph: not displayed,” or “Display format: detailed,” “Number of display items: 10,” “Graph: displayed.” These display controls are reflected in the user's device or family/medical professionals' dashboard. As a technical effect, the analysis unit automates optimal information presentation according to the user's psychological state and usage situation, greatly improving visibility, understanding, and satisfaction. Unlike conventional uniform display or manual settings by humans, the combination of real-time emotion estimation by AI and display optimization algorithms reduces the risk of information overload or oversight and improves user experience. Specific application fields include health management dashboards for the elderly, mental disorder monitoring, remote medical support, and information sharing in care facilities. Furthermore, the analysis unit can integrate and manage emotion and display histories from multiple users in the cloud, enabling personalized optimization of display policies. Thus, the analysis unit possesses high novelty and inventive technical value, contributing not only to the automation of human tasks but also to the improvement of computer technology itself and the resolution of social issues.

The analysis unit can determine the priority of analysis during analysis based on the time zone of the conversation. For example, the analysis unit may prioritize analysis of conversations conducted in the morning. The analysis unit may also prioritize analysis of conversations conducted at night. Furthermore, the analysis unit may adjust the priority of analysis based on the time zone of the user's conversation. By determining the priority of analysis based on the time zone of the conversation, analysis can be performed efficiently. Some or all of the above-described processing in the analysis unit may be performed using AI or without using AI. For example, the analysis unit may input conversation time zone data into generative AI and determine the priority of analysis. Specifically, the analysis unit receives timestamps attached to conversation data received from the recording unit (e.g., 2024-06-01 07:30:00, 2024-06-01 20:15:00) as input. The analysis unit uses time-series clustering algorithms (e.g., K-means, DBSCAN) and frequency analysis algorithms to extract trends and abnormal patterns for each conversation occurrence time zone. Input examples include “Conversation A: 07:30,content: about breakfast,” “Conversation B: 20:15, content: can't sleep.” The AI model outputs policies such as “Priority analysis time zone: nighttime,” “Analysis priority: nighttime >morning >daytime” based on these time zone data. If health risks or emotional changes are likely to appear in nighttime conversations, the analysis unit analyzes nighttime conversations with the highest priority, and adjusts the priority of morning conversations as indicators of life rhythm or activity level. Output examples include “Analysis target: nighttime conversation,” “Priority: 1,” “Analysis reason: risk of sleep disorder.” These priorities are reflected in the analysis scheduler and data supply to the alert generation unit. As a technical effect, the analysis unit realizes efficient resource allocation and improved risk detection capability according to the time zone of conversation occurrence. Unlike conventional uniform analysis or manual selection by humans, the combination of time zone analysis and priority optimization algorithms by AI achieves both early detection, rapid response, and improved analysis efficiency. Specific application fields include life rhythm monitoring for the elderly, risk assessment for sleep disorders, detection of nighttime symptoms in mental disorders, and nighttime monitoring in care facilities. Furthermore, the analysis unit can integrate and manage conversation time zones and analysis histories from multiple users in the cloud, enabling personalized optimization of analysis priorities. Thus, the analysis unit possesses high novelty and inventive technical value, contributing not only to the automation of human tasks but also to the improvement of computer technology itself and the resolution of social issues.

The analysis unit can adjust the order of analysis during analysis based on the relevance of the conversation. For example, the analysis unit may prioritize analysis of conversations in which the user discussed important topics. The analysis unit may also adjust the order of analysis based on the relevance of the user's conversations. Furthermore, the analysis unit may prioritize analysis of topics that the user discusses frequently. By adjusting the order of analysis based on the relevance of the conversation, important conversations can be analyzed preferentially. Some or all of the above-described processing in the analysis unit may be performed using AI or without using AI. For example, the analysis unit may input conversation relevance data into generative AI and adjust the order of analysis. Specifically, the analysis unit receives conversation text data (e.g., “I went to the hospital today,” “I'm worried about the test results,” “I called my family”) and topic labels (e.g., health, family, hobbies), as well as conversation frequency data (e.g., health topic 5 times per week, family topic 3 times per week) from the recording unit as input. The analysis unit uses topic classification models based on BERT or Transformer and relevance scoring algorithms (e.g., cosine similarity, TF-IDF) to calculate importance and relevance scores for each conversation (e.g., health-related 0.95, family-related 0.80). Input examples include “Conversation: I'm worried about my high blood pressure,” “Topic: health,” “Frequency: 5 times per week.” The AI model outputs “Relevance score: 0.92,” “Priority analysis: health-related conversation.” The analysis unit dynamically determines the order of analysis (e.g., health>family>hobbies) based on relevance scores and topic frequency, and analyzes important conversations with the highest priority. Output examples include “Analysis order: health>family>hobbies,” “Priority: 1.” These order controls are reflected in the analysis scheduler and data supply to the alert generation unit. As a technical effect, the analysis unit realizes efficient resource allocation and improved risk detection capability according to the importance and relevance of conversation content. Unlike conventional uniform analysis or manual selection by humans, the combination of topic classification, relevance scoring, and order optimization algorithms by AI achieves both early detection, rapid response, and improved analysis efficiency. Specific application fields include priority analysis of health risks for the elderly, extraction of important conversations in mental disorders, and multipurpose conversation analysis in care facilities. Furthermore, the analysis unit can integrate and manage conversation relevance and analysis histories from multiple users in the cloud, enabling personalized optimization of analysis order. Thus, the analysis unit possesses high novelty and inventive technical value, contributing not only to the automation of human tasks but also to the improvement of computer technology itself and the resolution of social issues.

The provision unit can estimate the user's emotion and adjust the content of the alert based on the estimated emotion of the user. For example, when the user is feeling stressed, the provision unit provides alerts using gentle language. When the user is relaxed, the provision unit can provide alerts containing detailed information. Furthermore, when the user is in a hurry, the provision unit can provide concise and prompt alerts. By adjusting the alert content based on emotion, appropriate alerts can be provided. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the provision unit may be performed using AI or without using AI. For example, the provision unit can input the user's emotion data into generative AI and adjust the alert content based on the emotion. Specifically, the provision unit inputs the user's voice waveform data (e.g., 16 kHz sampling, 16 bit PCM, 10 seconds of audio), facial image data (e.g., 30 fps, 640×480 pixels), and text data (e.g., “I am tired today”) into an emotion estimation module. The provision unit uses a multimodal emotion estimation model based on convolutional neural networks, LSTM, or Transformer to integrate acoustic features (e.g., F0, energy), facial features (e.g., degree of mouth corner lift), and text features (e.g., frequency of negative words), and outputs emotion labels (e.g., stress, relaxation, hurry) and emotion scores (e.g., stress 0.82,relaxation 0.15). Examples of input include “voice: speech with sighs,” “facial expression: furrowed brow,” “text: busy today,” etc. The AI model outputs scores such as “stress: 0.85,” “hurry: 0.70.” The provision unit uses these emotion scores for threshold judgment (e.g., gentle alert for stress score of 0.8 or higher, alert with detailed information for relaxation score of 0.7 or higher, concise alert for hurry score of 0.7 or higher), and dynamically controls template selection and style control parameters (e.g., tone, amount of information, sentence length) of the alert generation module. For example, in a stress state, gentle expressions such as “Please do not overexert yourself, and consult your family when necessary” are generated; in a relaxed state, alerts containing detailed information such as “Your health status today is good. Please check the details in the app” are generated; and in a hurry, concise alerts such as “Physical condition change detected. Please consult a doctor” are generated. Output examples include “alert content: gentle expression,” “alert content: with detailed information,” “alert content: concise,” etc. These alert contents are passed to a speech synthesis module or text notification module and delivered in real time to user terminals or terminals of family members and medical professionals. As a technical effect, the provision unit automatically generates optimal alert content according to the user's psychological state and usage situation, greatly improving the acceptability, persuasiveness, and action-inducing power of information transmission. Unlike conventional uniform alerts or manual selection of wording by humans, the combination of real-time emotion estimation by AI and alert content optimization algorithms reduces misunderstanding and stress and improves user satisfaction. Specific application fields include home monitoring for the elderly, mental disorder monitoring, remote medical support, and health management in nursing care facilities. Furthermore, the provision unit can integrate and manage the emotion and alert history of multiple users on the cloud, enabling personalized optimization of alert content and expression style. Thus, the provision unit has high technical value in novelty and inventive step, contributing not only to the automation of human tasks but also to the improvement of computer technology itself and the solution of social issues.

The provision unit can refer to the user's past health history when providing alerts and select optimal alert content. For example, the provision unit selects appropriate alert content based on the user's past health history. The provision unit can also provide alerts containing important information based on the user's health history. Furthermore, the provision unit can refer to the user's past health data to select optimal alert content. By referring to past health history, optimal alert content can be provided. Some or all of the above-described processing in the provision unit may be performed using AI or without using AI. For example, the provision unit can input the user's past health data into generative AI and select optimal alert content. Specifically, the provision unit accepts as input health data accumulated over time for each user (e.g., numerical vectors for body temperature, blood pressure, heart rate, sleep duration, activity amount over the past year) and conversation data (e.g., content of speech related to health). The provision unit uses time-series analysis models such as LSTM or Transformer to extract trends and variation patterns in past health indicators and analyze correlations with current health status and conversation content. Examples of input include “blood pressure over the past 30 days: 120/80→130/85→140/90,” “sleep duration: 7.5 h→6.0 h→5.0 h,” “conversation: Recently, I have trouble sleeping,” etc. The AI model integrates these time-series data and conversation content to generate outputs such as “health risk score: 0.82,” “confidence: high,” etc. The provision unit applies deviation analysis and anomaly detection algorithms (e.g., Isolation Forest, One-Class SVM) to past data and attaches reliability indicators to alert content (e.g., confidence score 0.95, anomaly detection label 1). The alert generation module generates specific alert content tailored to the user's history based on these reliability indicators and health risk scores, such as “Blood pressure has continued to rise over the past month. Consultation with a physician is recommended,” or “Sleep duration has been decreasing. It is recommended to review your daily routine.” Output examples include “alert content: continued blood pressure increase,” “alert content: tendency toward sleep deprivation,” etc. These alert contents are passed to a speech synthesis module or text notification module and delivered in real time to user terminals or terminals of family members and medical professionals. As a technical effect, the provision unit greatly improves the usefulness, persuasiveness, and action-inducing power of information by generating individually optimized alerts utilizing each user's health history. Unlike conventional simple current value judgment or subjective evaluation by humans, the combination of time-series history analysis and anomaly detection algorithms by AI reduces false detection rates and improves reliability. Specific application fields include chronic disease management for the elderly, risk assessment for lifestyle-related diseases, long-term monitoring of mental disorders, and health management in nursing care facilities. Furthermore, the provision unit can integrate and manage the health history and alert history of multiple users on the cloud, enabling personalized optimization of alert content and notification policies. Thus, the provision unit has high technical value in novelty and inventive step, contributing not only to the automation of human tasks but also to the improvement of computer technology itself and the solution of social issues.

The provision unit can adjust the timing of alerts based on the user's current living conditions when providing alerts. For example, when the user is busy, the provision unit adjusts the timing of alerts accordingly. The provision unit can also optimize the timing of alerts according to the user's living conditions. Furthermore, the provision unit can adjust the timing of alerts based on the user's current situation. By adjusting the timing of alerts based on living conditions, alerts can be provided at appropriate times. Some or all of the above-described processing in the provision unit may be performed using AI or without using AI. For example, the provision unit can input the user's living condition data into generative AI and adjust the timing of alerts. Specifically, the provision unit accepts as input the user's living condition data (e.g., status such as at home, out, visiting hospital, sleeping; calendar schedule; activity data) and real-time behavior logs (e.g., smartphone accelerometer, GPS, app usage history). The provision unit uses a living condition determination module (e.g., state classification model using random forest or LSTM) and scheduling algorithms (e.g., priority queue, calendar integration) to classify the user's current situation as “busy,” “normal,” “resting,” etc., and optimize the timing of alert issuance. Examples of input include “living condition: out,” “calendar: hospital visit scheduled,” “activity level: high,” etc. The AI model generates outputs such as “optimal timing: after returning home,” “priority: high,” etc. Based on these outputs, the provision unit performs timing control such as “hold alerts while out and notify after returning home,” “immediate notification of only high-priority alerts during busy times,” “notify the next morning during rest,” etc. Output examples include “alert timing: after returning home,” “alert timing: next morning,” etc. These timing controls are reflected in the alert notification module or the notification scheduler of the user terminal. As a technical effect, the provision unit automatically adjusts the optimal timing of alerts according to the user's living context and behavioral situation, greatly improving the acceptability, action-inducing power, and stress reduction of information transmission. Unlike conventional uniform notifications or manual timing settings by humans, the combination of real-time state determination and scheduling algorithms by AI prevents missed notifications and improves user satisfaction. Specific application fields include home monitoring for the elderly, remote medical support, health management in nursing care facilities, and support for daily rhythm in mental disorder patients. Furthermore, the provision unit can integrate and manage the living condition and alert history of multiple users on the cloud, enabling personalized optimization of notification timing. Thus, the provision unit has high technical value in novelty and inventive step, contributing not only to the automation of human tasks but also to the improvement of computer technology itself and the solution of social issues.

The provision unit can estimate the user's emotion and determine the priority of alerts based on the estimated emotion of the user. For example, when the user is feeling stressed, the provision unit prioritizes important alerts. When the user is relaxed, the provision unit can provide all alerts equally. Furthermore, when the user is in a hurry, the provision unit can prioritize urgent alerts. By determining the priority of alerts based on emotion, important alerts can be provided preferentially. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the provision unit may be performed using AI or without using AI. For example, the provision unit can input the user's emotion data into generative AI and determine the priority of alerts based on emotion. Specifically, the provision unit inputs the user's voice waveform data, facial image data, and text data into an emotion estimation module, and uses a multimodal emotion estimation model based on convolutional neural networks, LSTM, or Transformer to output emotion labels (e.g., stress, relaxation, hurry) and emotion scores (e.g., stress 0.80,relaxation 0.10). Examples of input include “voice: fast and tense speech,” “facial expression: furrowed brow,” “text: I am in a hurry,” etc. The AI model outputs scores such as “hurry: 0.85,” “stress: 0.75.” The provision unit uses these emotion scores for threshold judgment (e.g., stress score of 0.7 or higher: prioritize medical/health-related alerts; relaxation score of 0.7 or higher: notify all alerts equally; hurry score of 0.7 or higher: notify only urgent alerts immediately), and dynamically controls priority control parameters (e.g., notification order, notification interval, notification format) of the alert notification module. For example, in a stress state, medical and family-related alerts are notified with highest priority; in a relaxed state, all alerts are notified equally; and in a hurry, only urgent alerts are notified immediately. Output examples include “alert priority: medical>family>others,” “notification method: urgent only,” etc. These priorities are reflected in the alert notification module or the notification scheduler of the user terminal. As a technical effect, the provision unit can minimize the user's psychological burden and information overload while comprehensively and efficiently transmitting important information. Unlike conventional uniform notifications or manual selection by humans, the combination of real-time emotion estimation and notification priority optimization algorithms by AI achieves both notification efficiency and user satisfaction. Specific application fields include home monitoring for the elderly, mental disorder monitoring, remote medical support, and efficiency improvement of recording operations in nursing care facilities. Furthermore, the provision unit can integrate and manage the emotion and alert history of multiple users on the cloud, enabling personalized optimization of notification priorities. Thus, the provision unit has high technical value in novelty and inventive step, contributing not only to the automation of human tasks but also to the improvement of computer technology itself and the solution of social issues.

The provision unit can consider the user's geographic location information when providing alerts and select optimal alert content. For example, when the user is at a specific location, the provision unit provides alerts related to that location. The provision unit can also select appropriate alert content based on the user's geographic location information. Furthermore, when the user is moving, the provision unit can provide alerts related to the destination. By providing optimal alert content based on geographic location information, useful information can be provided to the user. Some or all of the above-described processing in the provision unit may be performed using AI or without using AI. For example, the provision unit can input the user's geographic location information into generative AI and select optimal alert content. Specifically, the provision unit accepts as input geographic location data obtained from the GPS sensor or Wi-Fi location estimation module of the user terminal (e.g., latitude/longitude, location labels such as “home,” “hospital,” “park”), and movement history data (e.g., movement route over the past 24 hours, movement speed, duration of stay). The provision unit uses a geographic information analysis module (e.g., map API integration, location clustering algorithm) and a natural language processing module (e.g., BERT-based topic classification model) to calculate relevance scores between conversation content, health risk information, and location (e.g., health-related alert score at hospital 0.95, exercise-related alert score at park 0.88). Examples of input include “location: hospital,” “moving: home→hospital,” “conversation: I am worried about the test results,” etc. The AI model integrates these geographic location data and conversation/health data to generate outputs such as “relevance score: 0.92,” “priority alert: health-related,” etc. Based on these scores and labels, the provision unit dynamically controls alert content for each location. For example, at a hospital, alerts prompting confirmation of test results or consultation with a physician are generated; at a park, alerts for increased exercise or heatstroke prevention are generated; and while moving, health management advice related to the destination is generated. Output examples include “alert content: health management at hospital,” “alert content: exercise recommendation at park,” etc. These alert contents are passed to a speech synthesis module or text notification module and delivered in real time to user terminals or terminals of family members and medical professionals. As a technical effect, the provision unit efficiently generates and delivers highly relevant alerts according to the user's behavioral context and living environment, greatly improving the usefulness, persuasiveness, and action-inducing power of information transmission. Unlike conventional uniform notifications or manual selection by humans, the combination of integrated analysis of geographic and health information and alert optimization algorithms by AI reduces false report rates and improves user satisfaction. Specific application fields include health monitoring for the elderly when going out, medical record management for outpatients, optimization of behavioral records in nursing care facilities, and evacuation support alerts during disasters. Furthermore, the provision unit can integrate and manage the geographic information and alert history of multiple users on the cloud, enabling personalized optimization of alert content and notification policies. Thus, the provision unit has high technical value in novelty and inventive step, contributing not only to the automation of human tasks but also to the improvement of computer technology itself and the solution of social issues.

The provision unit can analyze the user's social media activity when providing alerts and adjust the content of the alerts. For example, the provision unit provides alerts related to topics that the user is discussing on social media. The provision unit can also select important alerts based on the user's social media activity. Furthermore, the provision unit can adjust the content of alerts based on the user's social media activity. By analyzing social media activity, relevant alert content can be provided. Some or all of the above-described processing in the provision unit may be performed using AI or without using AI. For example, the provision unit can input the user's social media data into generative AI and adjust the content of alerts. Specifically, the provision unit accepts as input the user's social media post data (e.g., text posts, image posts, posting time, topic labels), conversation text data (e.g., “I talked with friends on SNS today”), and posting frequency data (e.g., 5 posts per day, 30 posts per week). The provision unit uses a natural language processing module (e.g., BERT-based topic classification model), image analysis module (e.g., CNN for image content classification), and posting frequency analysis algorithm to calculate relevance scores between social media activity and conversation content related to health risks or lifestyle habits (e.g., match score between health topics trending on SNS and conversation content 0.90). Examples of input include “SNS post: about health checkup,” “conversation: concerned about test results,” etc. The AI model outputs “relevance score: 0.88,” “priority alert: health-related,” etc. Based on these scores and labels, the provision unit preferentially generates alerts related to trending topics on SNS and extracts highly important alert content. For example, if “influenza outbreak” is trending on SNS, an alert recommending vaccination and handwashing is generated; if “lack of exercise” is trending, an alert recommending improvement of exercise habits is generated. Output examples include “alert content: influenza prevention,” “alert content: exercise recommendation,” etc. These alert contents are passed to a speech synthesis module or text notification module and delivered in real time to user terminals or terminals of family members and medical professionals. As a technical effect, the provision unit efficiently generates and delivers highly relevant alerts according to the user's social interests and information dissemination tendencies, greatly improving the usefulness, persuasiveness, and action-inducing power of information transmission. Unlike conventional uniform notifications or manual selection by humans, the combination of integrated analysis of social media and health information and alert optimization algorithms by AI reduces false report rates and improves user satisfaction. Specific application fields include monitoring social interactions of the elderly, analysis of information dissemination by mental disorder patients, efficiency improvement of recording operations in nursing care facilities, and alerting during infectious disease outbreaks. Furthermore, the provision unit can integrate and manage the SNS activity and alert history of multiple users on the cloud, enabling personalized optimization of alert content and notification policies. Thus, the provision unit has high technical value in novelty and inventive step, contributing not only to the automation of human tasks but also to the improvement of computer technology itself and the solution of social issues.

The voice assist unit can estimate the user's emotion and adjust the tone and tempo of speech based on the estimated emotion of the user. For example, when the user is nervous, the voice assist unit speaks in a calm tone. When the user is relaxed, the voice assist unit can speak in a bright tone. Furthermore, when the user is in a hurry, the voice assist unit can speak in a quick and concise tempo. By adjusting the tone and tempo of speech based on emotion, comfortable conversation for the user is enabled. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the voice assist unit may be performed using AI or without using AI. For example, the voice assist unit can input the user's emotion data into generative AI and adjust the tone and tempo of speech based on emotion. Specifically, the voice assist unit inputs the user's voice waveform data (e.g., 16 kHz sampling, 16 bit PCM, 10 seconds of audio data), facial image data (e.g., 30 fps, 640×480 pixels), and text data (e.g., “I am nervous today”) into an emotion estimation module. The voice assist unit uses a multimodal emotion estimation model based on convolutional neural networks, LSTM, or Transformer to integrate acoustic features (e.g., F0, energy), facial features (e.g., degree of eye opening, movement of mouth corners), and text features (e.g., frequency of negative words), and outputs emotion labels (e.g., nervousness, relaxation, hurry) and emotion scores (e.g., nervousness 0.82, relaxation 0.15). Examples of input include “voice: fast and nervous speech,” “facial expression: eyes wide open,” “text: I am worried,” etc. The AI model outputs scores such as “nervousness: 0.85,” “relaxation: 0.12.” The voice assist unit uses these emotion scores for threshold judgment (e.g., nervousness score of 0.8 or higher: calm tone and reduce speed to 0.8×; relaxation score of 0.7 or higher: bright tone and increase speed to 1.1×; hurry score of 0.7 or higher: increase tempo to 1.3×), and dynamically controls acoustic parameters (e.g., pitch, speed, formant emphasis, spectral envelope adjustment) of the speech synthesis module (e.g., neural speech synthesis models such as WaveNet or Tacotron). For example, in a nervous state, a calm voice such as “Please relax. Let's talk slowly” is generated; in a relaxed state, a bright voice such as “It looks like today will be a wonderful day” is generated; and in a hurry, a quick tempo such as “I will convey your request concisely” is used. Output examples include “voice waveform data: calm voice,” “voice features: F0=150 Hz, speed=0.8×,” etc. The generated voice is played from the speaker of the user terminal, promoting natural dialogue with the user. In subsequent processing, the user's response voice is acquired again by the recording unit and used for analysis of conversation history and emotional changes. As a technical effect, the voice assist unit, unlike conventional simple voice playback or reading of fixed phrases, realizes individually optimized voice generation by integrating high-dimensional acoustic feature control by neural networks and user emotion information. This enables psychological comfort, promotion of conversation, and stress reduction for the user. Specific application fields include home monitoring for the elderly, remote medical support, psychological care in nursing care facilities, and prevention of isolation for elderly living alone. Furthermore, the voice assist unit can integrate and manage the emotion and conversation history of multiple users on the cloud, enabling automatic optimization of personalized voice styles. Thus, the voice assist unit has high technical value in novelty and inventive step, contributing not only to the automation of human tasks but also to the improvement of computer technology itself and the solution of social issues.

The voice assist unit can refer to the user's past conversation history during voice assistance and select the optimal way of speaking. For example, the voice assist unit selects a friendly way of speaking based on topics the user has enjoyed discussing in the past. The voice assist unit can also use specific phrases or words from the user's past conversation history when speaking. Furthermore, the voice assist unit can refer to patterns of conversations in which the user was relaxed in the past to select the optimal way of speaking. By referring to past conversation history, a friendly way of speaking can be selected. Some or all of the above-described processing in the voice assist unit may be performed using AI or without using AI. For example, the voice assist unit can input the user's past conversation data into generative AI and select the optimal way of speaking. Specifically, the voice assist unit accepts as input time-series accumulated conversation text data for each user (e.g., 10 entries per day, about 100 characters per entry), conversation topic labels (e.g., health, family, hobbies), conversation occurrence times (e.g., 7 a.m., 8 p.m.), and emotion scores during conversation (e.g., relaxation 0.85, stress 0.12). The voice assist unit uses a natural language processing module (e.g., BERT-based topic classification model), time-series clustering algorithms (e.g., K-means, DBSCAN), and frequency analysis algorithms (e.g., Apriori method) to extract distributions of past conversation topics, speech frequency patterns, and conversation patterns during relaxation. Examples of input include “distribution of conversation topics over the past 30 days: health 40%, family 30%, hobbies 20%, others 10%” and “conversation pattern during relaxation: question-answer type.” The AI model outputs speaking policies such as “priority speaking topics: health, family,” “recommended phrases: How are you feeling today?” “recommended speaking pattern: question-answer type.” Furthermore, conversation patterns (e.g., continuous speech, single utterance, question-answer type) are analyzed by time-series models such as LSTM or Transformer, and optimal speaking methods such as “record all entries during continuous speech, summarize only during single utterance” are proposed. Output examples include “speaking content: health/family topics,” “speaking method: question-answer type,” “recommended phrase: Have you been enjoying your hobbies lately?” etc. These ways of speaking are reflected in the speech synthesis module or conversation generation module and played from the speaker of the user terminal. As a technical effect, the voice assist unit automatically selects the optimal way of speaking tailored to each user's conversation tendencies and psychological state, improving the usefulness, friendliness, and psychological comfort of conversations. Unlike conventional uniform speaking or manual selection by humans, the combination of pattern extraction and optimization algorithms by AI achieves both conversation efficiency and user experience. Specific application fields include life monitoring for the elderly, analysis of conversation patterns in mental disorder patients, remote medical support, and efficiency improvement of conversation operations in nursing care facilities. Furthermore, the voice assist unit can integrate and manage the conversation history of multiple users on the cloud, enabling personalized optimization of ways of speaking. Thus, the voice assist unit has high technical value in novelty and inventive step, contributing not only to the automation of human tasks but also to the improvement of computer technology itself and the solution of social issues.

The voice assist unit can customize the content of speech during voice assistance based on the user's current health status. For example, when the user is feeling unwell, the voice assist unit speaks with content that shows concern for the user's condition. When the user is healthy, the voice assist unit can speak with content that encourages daily activities. Furthermore, the voice assist unit can provide appropriate advice or information based on the user's health status. By customizing the content of speech based on health status, appropriate advice and information can be provided. Some or all of the above-described processing in the voice assist unit may be performed using AI or without using AI. For example, the voice assist unit can input the user's health data into generative AI and customize the content of speech. Specifically, the voice assist unit accepts as input health status data obtained from the user terminal or wearable device (e.g., body temperature 36.8° C., blood pressure 125/80 mmHg, heart rate 72 bpm, sleep duration 7.2 hours, self-reported health score 0.9) in multidimensional vector format. In addition to these health data, the voice assist unit also refers to past health history and conversation history (e.g., changes in condition over the past week, content of health consultations), and uses a health status determination module (e.g., random forest, LSTM, Transformer-based health status classification model) to classify the user's state as “unwell,” “normal,” or “good.” Examples of input include “body temperature: 37.8° C.,” “heart rate: 95 bpm,” “sleep duration: 4.5 hours,” “conversation: I haven't been sleeping well lately,” etc. The AI model generates outputs such as “health status: unwell,” “risk score: 0.85.” Based on these health status labels and risk scores, the voice assist unit inputs templates or prompts such as “show concern and recommend rest when unwell,” “encourage activity and provide health maintenance advice when normal,” “give positive encouragement when good” into the conversation generation module (e.g., LLM or encoder-decoder type generation model) to generate optimal speech content. Output examples include “speech content: It seems you are not feeling well today. Please take it easy and rest,” “speech content: You seem to be in good health. How about going for a walk?” etc. The generated text is passed to the speech synthesis module (e.g., WaveNet or Tacotron), and converted into speech with optimal voice quality and tone according to user attributes and emotion information. In subsequent processing, the user's response and changes in health status are accumulated by the recording unit and used for optimization of future speech content and health risk analysis. As a technical effect, the voice assist unit, unlike conventional uniform reading of fixed phrases or manual response by humans, automates individually optimized voice assistance tailored to the user's health status by combining high-dimensional health data analysis and conversation generation algorithms by AI. This enables improvement of user comfort and trust, early detection and response to health risks, and qualitative improvement of the conversation experience. Specific application fields include home health monitoring for the elderly, self-care support for chronic disease patients, remote medical support, and promotion of health management in nursing care facilities. Furthermore, the voice assist unit can integrate and manage the health and conversation history of multiple users on the cloud, enabling personalized optimization of speech content and advice. Thus, the voice assist unit has high technical value in novelty and inventive step, contributing not only to the automation of human tasks but also to the improvement of computer technology itself and the solution of social issues.

The voice assist unit can estimate the user's emotion and determine the priority of voice assistance based on the estimated emotion of the user. For example, when the user is feeling stressed, the voice assist unit prioritizes voice assistance that promotes relaxation. When the user is relaxed, the voice assist unit can prioritize daily conversation. Furthermore, when the user is in a hurry, the voice assist unit can prioritize voice assistance that provides important information quickly. By determining the priority of voice assistance based on emotion, important information can be provided preferentially to the user. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the voice assist unit may be performed using AI or without using AI. For example, the voice assist unit can input the user's emotion data into generative AI and determine the priority of voice assistance based on emotion. Specifically, the voice assist unit inputs the user's voice waveform data (e.g., 16 kHz sampling, 16 bit PCM, 10 seconds of audio), facial image data (e.g., 30 fps, 640×480 pixels), and text data (e.g., “I am tired today”) into an emotion estimation module. The voice assist unit uses a multimodal emotion estimation model based on convolutional neural networks, LSTM, or Transformer to integrate acoustic features (e.g., F0, energy), facial features (e.g., degree of mouth corner lift, degree of eye opening), and text features (e.g., frequency of negative and positive words), and outputs emotion labels (e.g., stress, relaxation, hurry) and emotion scores (e.g., stress 0.82, relaxation 0.15, hurry 0.65). Examples of input include “voice: speech with sighs,” “facial expression: furrowed brow,” “text: busy today,” etc. The AI model outputs scores such as “stress: 0.85,” “hurry: 0.70.” The voice assist unit uses these emotion scores for threshold judgment (e.g., stress score of 0.8 or higher: prioritize relaxation assistance; relaxation score of 0.7 or higher: prioritize daily conversation assistance; hurry score of 0.7 or higher: prioritize important information assistance), and dynamically controls priority control parameters (e.g., selection order of conversation content, notification interval, conversation tempo) of the voice assist generation module. For example, in a stress state, guides for deep breathing and reassuring speech are provided with highest priority; in a relaxed state, topics such as hobbies and daily life, and casual conversation are prioritized; and in a hurry, reminders of schedules and important health information are provided concisely. Output examples include “assist priority: relaxation promotion>daily conversation>important information,” “notification method: urgent only,” etc. These priorities are reflected in the speech synthesis module or conversation generation module and played from the speaker of the user terminal. In subsequent processing, the user's response and emotional changes are accumulated by the recording unit and used for optimization of future assist priorities and personalization of conversation content. As a technical effect, the voice assist unit, unlike conventional uniform conversation provision or manual response by humans, automates optimal voice assistance tailored to the user's psychological state and usage situation by combining real-time emotion estimation and priority optimization algorithms by AI. This enables stress reduction, improvement of information transmission efficiency, and qualitative improvement of the conversation experience for the user. Specific application fields include psychological care for the elderly, stress management for mental disorder patients, remote medical support, and efficiency improvement of conversation operations in nursing care facilities. Furthermore, the voice assist unit can integrate and manage the emotion and conversation history of multiple users on the cloud, enabling personalized optimization of assist priorities and conversation content. Thus, the voice assist unit has high technical value in novelty and inventive step, contributing not only to the automation of human tasks but also to the improvement of computer technology itself and the solution of social issues.

The voice assist unit can consider the user's geographic location information during voice assistance and select the optimal way of speaking. For example, when the user is at a specific location, the voice assist unit speaks about topics related to that location. The voice assist unit can also select appropriate ways of speaking based on the user's geographic location information. Furthermore, when the user is moving, the voice assist unit can select ways of speaking that provide information related to the destination. By selecting the optimal way of speaking based on geographic location information, useful information can be provided to the user. Some or all of the above-described processing in the voice assist unit may be performed using AI or without using AI. For example, the voice assist unit can input the user's geographic location information into generative AI and select the optimal way of speaking. Specifically, the voice assist unit accepts as input geographic location data obtained from the GPS sensor or Wi-Fi location estimation module of the user terminal (e.g., latitude/longitude, location labels such as “home,” “hospital,” “park”), movement history data (e.g., movement route over the past 24 hours, movement speed, duration of stay), and conversation history data (e.g., past conversation content for each location). The voice assist unit uses a geographic information analysis module (e.g., map API integration, location clustering algorithm) and a natural language processing module (e.g., BERT-based topic classification model) to calculate relevance scores between current location or destination and conversation content (e.g., health-related topic score at hospital 0.95, exercise-related topic score at park 0.88). Examples of input include “location: hospital,” “moving: home →hospital,” “conversation: I am worried about the test results,” etc. The AI model generates outputs such as “relevance score: 0.92,” “priority speaking: health-related,” etc. Based on these scores and labels, the voice assist unit dynamically controls speaking content and style for each location (e.g., health management advice, exercise recommendation, destination guidance). For example, at a hospital, speech prompting confirmation of test results or consultation with a physician is generated; at a park, speech recommending increased exercise or caution against heatstroke is generated; and while moving, health management advice related to the destination is generated. Output examples include “speaking content: health management at hospital,” “speaking content: exercise recommendation at park,” etc. The generated text is passed to the speech synthesis module and converted into speech with optimal voice quality and tone according to user attributes and emotion information. In subsequent processing, the user's response and movement history are accumulated by the recording unit and used for optimization of future speaking content and behavioral pattern analysis. As a technical effect, the voice assist unit, unlike conventional uniform conversation provision or manual response by humans, automates highly relevant voice assistance tailored to the user's behavioral context and living environment by combining integrated analysis of geographic information and conversation content and optimization algorithms for speaking content. This enables improvement of information acceptability, persuasiveness, action-inducing power, optimization of daily rhythm, and reduction of health risks for the user. Specific application fields include health monitoring for the elderly when going out, medical support for outpatients, optimization of behavioral records in nursing care facilities, and evacuation guidance during disasters. Furthermore, the voice assist unit can integrate and manage the geographic information and conversation history of multiple users on the cloud, enabling personalized optimization of speaking content and guidance policies. Thus, the voice assist unit has high technical value in novelty and inventive step, contributing not only to the automation of human tasks but also to the improvement of computer technology itself and the solution of social issues.

The voice assist unit can analyze the user's social media activity during voice assistance and adjust the content of speech. For example, the voice assist unit speaks about topics related to those the user is discussing on social media. The voice assist unit can also speak with content containing important information based on the user's social media activity. Furthermore, the voice assist unit can adjust the content of speech based on the user's social media activity. By analyzing social media activity, relevant speaking content can be provided. Some or all of the above-described processing in the voice assist unit may be performed using AI or without using AI. For example, the voice assist unit can input the user's social media data into generative AI and adjust the content of speech. Specifically, the voice assist unit accepts as input the user's social media post data (e.g., text posts, image posts, posting time, topic labels), conversation text data (e.g., “I talked with friends on SNS today”), and posting frequency data (e.g., 5 posts per day, 30 posts per week). The voice assist unit uses a natural language processing module (e.g., BERT-based topic classification model), image analysis module (e.g., CNN for image content classification), and posting frequency analysis algorithm to calculate relevance scores between social media activity and conversation content (e.g., match score between health topics trending on SNS and conversation content 0.90). Examples of input include “SNS post: about health checkup,” “conversation: concerned about test results,” etc. The AI model outputs “relevance score: 0.88,” “priority speaking: health-related,” etc. Based on these scores and labels, the voice assist unit extracts speaking content related to trending topics on SNS and highly important information, and inputs prompts such as “linked to SNS topics” and “priority to important information” into the conversation generation module (e.g., LLM or encoder-decoder type generation model) to generate optimal speaking content. For example, if “influenza outbreak” is trending on SNS, content such as “Influenza is spreading recently. Please consider vaccination and handwashing” is generated; if “lack of exercise” is trending, content such as “How about reviewing your exercise habits?” is generated. Output examples include “speaking content: influenza prevention,” “speaking content: exercise recommendation,” etc. The generated text is passed to the speech synthesis module and converted into speech with optimal voice quality and tone according to user attributes and emotion information. In subsequent processing, the user's response and SNS activity history are accumulated by the recording unit and used for optimization of future speaking content and personalization of information provision policies. As a technical effect, the voice assist unit, unlike conventional uniform conversation provision or manual response by humans, automates highly relevant voice assistance tailored to the user's social interests and information dissemination tendencies by combining integrated analysis of social media and conversation content and optimization algorithms for speaking content. This enables improvement of information acceptability, persuasiveness, action-inducing power, activation of social interaction, and reduction of health risks for the user. Specific application fields include monitoring social interactions of the elderly, analysis of information dissemination by mental disorder patients, efficiency improvement of conversation operations in nursing care facilities, and guidance during infectious disease outbreaks. Furthermore, the voice assist unit can integrate and manage the SNS activity and conversation history of multiple users on the cloud, enabling personalized optimization of speaking content and information provision policies. Thus, the voice assist unit has high technical value in novelty and inventive step, contributing not only to the automation of human tasks but also to the improvement of computer technology itself and the solution of social issues.

The system according to the embodiment is not limited to the examples described above and can be variously modified as follows. Specifically, the system can be additionally configured with various sensor devices, cloud integration modules, distributed processing infrastructure, edge AI inference units, and the like. The system can integrate diverse data sources such as voice, image, biometric, and environmental sensors, and expand the multimodal AI analysis platform. The system can also utilize parallel computing clusters using GPUs or FPGA accelerators to realize real-time large-scale data analysis and low-latency inference processing. Furthermore, the system can be equipped with an adaptive AI control module that automatically switches and personalizes AI models according to user attributes and usage environments. The AI model architecture may be a hybrid type combining various networks such as CNN, RNN, Transformer, Graph Neural Network, or may apply advanced learning methods such as transfer learning, self-supervised learning, and reinforcement learning. From the perspective of data flow, distributed cooperative processing that divides preprocessing and feature extraction on edge devices and integrated analysis on the cloud, or federated learning configurations for privacy protection, can also be implemented. Furthermore, the system can expand APIs for collaboration with medical institutions, nursing care facilities, family terminals, regional monitoring networks, and the like, thereby enhancing interoperability with external services and flexibility in data sharing. Through these variations, the system has high technical value in novelty and inventive step, contributing not only to the automation of human tasks but also to the improvement of computer technology itself (e.g., improved processing speed, accuracy, scalability, flexibility, enhanced security) and the solution of social issues.

The health risk reduction system may further include an exercise analysis unit that acquires the user's exercise data and analyzes changes in exercise amount. The exercise analysis unit records, for example, the user's number of steps and exercise time, and detects changes in daily exercise amount. If exercise amount decreases, health risks may increase, so an alert can be issued. For example, the exercise analysis unit records the number of steps the user walks in a day and detects a decrease in exercise amount by comparing with past data. The exercise analysis unit can also record the type and duration of exercise performed by the user and analyze changes in exercise habits. Furthermore, the exercise analysis unit can provide appropriate exercise advice based on the user's exercise data. This is expected to help reduce health risks due to lack of exercise and support the user's health maintenance. Specifically, the exercise analysis unit accepts as input step count data obtained from the user's wearable device or smartphone (e.g., 8,000 steps per day), exercise time (e.g., 30 minutes), exercise intensity (e.g., METs value), and exercise type (e.g., walking, jogging, stretching) in multidimensional vector format. The exercise analysis unit accumulates these exercise data over time and uses time-series analysis models such as LSTM or Transformer to extract trends and variation patterns in exercise amount over the past week or month. Examples of input include “step count over the past 7 days: 8,000→7,500→7,000→6,500→6,000→5,500→5,000,” “exercise type: walking,” “exercise intensity: 3.5 METs,” etc. The AI model generates outputs such as “trend of decreasing exercise amount: present,” “risk score: 0.78.” Based on these outputs, the exercise analysis unit applies threshold judgment algorithms (e.g., weekly average step count decreases by 20% or more compared to monthly average) or anomaly detection models (e.g., Isolation Forest) to determine whether to issue an alert. Output examples include “alert: decrease in exercise amount,” “recommended advice: resume light exercise,” etc. Furthermore, by considering user attributes such as age, health status, and medical history, individually optimized exercise advice (e.g., recommend stretching for the elderly, propose moderate exercise for those with chronic conditions) can also be generated. These advices are linked to the voice assist unit or notification module and provided to the user terminal in real time. As a technical effect, the exercise analysis unit, unlike conventional simple step count recording or manual evaluation by humans, realizes high-precision and early detection of changes in exercise habits and promotes health risk reduction and behavioral change by combining high-dimensional time-series analysis and anomaly detection algorithms by AI. Specific application fields include monitoring lack of exercise in the elderly, prevention of lifestyle-related diseases, rehabilitation support, and health management in nursing care facilities. Furthermore, the exercise analysis unit can integrate and manage the exercise history of multiple users on the cloud, enabling personalized optimization of exercise advice and alert criteria. Thus, the exercise analysis unit has high technical value in novelty and inventive step, contributing not only to the automation of human tasks but also to the improvement of computer technology itself and the solution of social issues.

The health risk reduction system may further include a diet analysis unit that acquires the user's dietary data and analyzes changes in dietary content. The diet analysis unit records, for example, the content and calories of meals consumed by the user and detects changes in nutritional balance. If nutritional balance is disrupted, health risks may increase, so an alert can be issued. For example, the diet analysis unit records the type and amount of food consumed by the user and detects changes in nutritional balance by comparing with past data. The diet analysis unit can also provide appropriate dietary advice based on the user's dietary data. Furthermore, the diet analysis unit can propose healthy meal plans based on the user's dietary data. This is expected to help reduce health risks due to nutritional deficiency or excessive intake and support the user's health maintenance. Specifically, the diet analysis unit accepts as input dietary content data obtained from the user's meal recording app or image recognition module (e.g., breakfast: 150 g rice, miso soup, grilled fish, 350 kcal), ingredient list, calorie intake, and nutrient amounts (e.g., protein 15 g, fat 10 g, carbohydrate 50 g) in multidimensional vector format. The diet analysis unit accumulates these dietary data over time and uses image analysis models such as CNN or Transformer and nutrient estimation models to automatically classify meal content and evaluate nutritional balance. Examples of input include “calorie intake over 1 week:

1,800→2,000→2,200→2,100→1,900→1,700→1,600,” “protein intake: 50 g/day,” “vegetable intake: 120 g/day,” etc. The AI model generates outputs such as “nutritional balance: biased,” “risk score: 0.82.” Based on these outputs, the diet analysis unit applies threshold judgment algorithms (e.g., weekly average calorie intake exceeds recommended value by 20% or more, vegetable intake below standard value) or anomaly detection models to determine whether to issue an alert. Output examples include “alert: excessive calorie intake,” “recommended advice: increase vegetable intake,” etc. Furthermore, by considering user attributes such as age, gender, and health status, individually optimized dietary advice and healthy meal plans (e.g., low-carb, reduced salt, balanced diet) can also be generated. These advices are linked to the voice assist unit or notification module and provided to the user terminal in real time. As a technical effect, the diet analysis unit, unlike conventional manual recording or subjective evaluation by humans, realizes high-precision and early detection of changes in dietary content and improvement of eating habits by combining high-dimensional dietary data analysis and nutritional balance evaluation algorithms by AI. Specific application fields include nutrition management for the elderly, prevention of lifestyle-related diseases, diet support, and meal management in nursing care facilities. Furthermore, the diet analysis unit can integrate and manage the dietary history of multiple users on the cloud, enabling personalized optimization of dietary advice and meal plans. Thus, the diet analysis unit has high technical value in novelty and inventive step, contributing not only to the automation of human tasks but also to the improvement of computer technology itself and the solution of social issues.

The health risk reduction system may further include a sleep analysis unit that acquires the user's sleep data and analyzes changes in sleep patterns. The sleep analysis unit records, for example, the user's sleep duration and sleep quality and detects changes in sleep patterns. If sleep quality decreases, health risks may increase, so an alert can be issued. For example, the sleep analysis unit records the user's sleep duration and detects changes in sleep duration by comparing with past data. The sleep analysis unit can also evaluate the user's sleep quality and detect decreases in sleep quality. Furthermore, the sleep analysis unit can provide appropriate sleep advice based on the user's sleep data. This is expected to help reduce health risks due to sleep deprivation or decreased sleep quality and support the user's health maintenance. Specifically, the sleep analysis unit accepts as input sleep duration data obtained from the user's wearable device or smartphone (e.g., 6.5 hours/day), sleep stages (e.g., deep sleep 2.0 hours, light sleep 3.5 hours, REM sleep 1.0 hour), sleep efficiency (e.g., 85%), sleep latency (e.g., 20 minutes), number of awakenings (e.g., 2 times), and other multidimensional vectors. The sleep analysis unit accumulates these sleep data over time and uses time-series analysis models such as LSTM or Transformer to extract changes and abnormal trends in sleep patterns (e.g., decrease in sleep duration, decrease in proportion of deep sleep, increase in number of awakenings). Examples of input include “sleep duration over the past 7 days:

7.0→6.8→6.5→6.0→5.8→5.5→5.0,” “proportion of deep sleep: 30%→25%→20%,” etc. The AI model generates outputs such as “trend of decreased sleep quality: present,” “risk score: 0.81.” Based on these outputs, the sleep analysis unit applies threshold judgment algorithms (e.g., weekly average sleep duration less than 6 hours, proportion of deep sleep less than 20%) or anomaly detection models to determine whether to issue an alert. Output examples include “alert: sleep deprivation,” “recommended advice: go to bed earlier,” etc. Furthermore, by considering user attributes such as age, daily rhythm, and health status, individually optimized sleep advice and sleep improvement plans (e.g., recommend relaxation before bedtime, restrict caffeine intake) can also be generated. These advices are linked to the voice assist unit or notification module and provided to the user terminal in real time. As a technical effect, the sleep analysis unit, unlike conventional manual recording or subjective evaluation by humans, realizes high-precision and early detection of changes in sleep patterns and improvement of sleep habits by combining high-dimensional sleep data analysis and anomaly detection algorithms by AI. Specific application fields include sleep disorder monitoring for the elderly, prevention of lifestyle-related diseases, sleep management for mental disorder patients, and sleep management in nursing care facilities. Furthermore, the sleep analysis unit can integrate and manage the sleep history of multiple users on the cloud, enabling personalized optimization of sleep advice and plans. Thus, the sleep analysis unit has high technical value in novelty and inventive step, contributing not only to the automation of human tasks but also to the improvement of computer technology itself and the solution of social issues.

The health risk reduction system may further include a stress analysis unit that measures the user's stress level and analyzes changes in stress. The stress analysis unit records, for example, the user's heart rate and skin conductance response and detects changes in stress level. If stress level increases, health risks may increase, so an alert can be issued. For example, the stress analysis unit records the user's heart rate and detects changes in stress level by comparing with past data. The stress analysis unit can also measure the user's skin conductance response and detect changes in stress level. Furthermore, the stress analysis unit can provide appropriate stress management advice based on the user's stress data. This is expected to help reduce health risks due to stress and support the user's health maintenance. Specifically, the stress analysis unit accepts as input heart rate data obtained from the user's wearable device or biometric sensor (e.g., resting heart rate 80 bpm, fluctuation ±10 bpm), skin conductance response (e.g., GSR value 0.25 μS), skin temperature, respiratory rate, and other multidimensional biometric signal vectors. The stress analysis unit accumulates these biometric data over time and uses time-series analysis models such as LSTM or Transformer and anomaly detection algorithms (e.g., Isolation Forest, One-Class SVM) to extract changes and abnormal trends in stress level (e.g., rapid increase in heart rate, sustained increase in GSR value). Examples of input include “heart rate over the past 7 days:

80→85→90→95→100→105→110,” “GSR value: 0.20→0.25→0.30,” etc. The AI model generates outputs such as “trend of increased stress level: present,” “risk score: 0.84.” Based on these outputs, the stress analysis unit applies threshold judgment algorithms (e.g., weekly average heart rate exceeds reference value by 15% or more, GSR value 0.3 μS or higher) to determine whether to issue an alert. Output examples include “alert: increased stress,” “recommended advice: take deep breaths and rest,” etc. Furthermore, by considering user attributes such as age, health status, and living environment, individually optimized stress management advice (e.g., relaxation methods, exercise recommendation, daily rhythm adjustment) can also be generated. These advices are linked to the voice assist unit or notification module and provided to the user terminal in real time. As a technical effect, the stress analysis unit, unlike conventional manual recording or subjective evaluation by humans, realizes high-precision and early detection of changes in stress level and optimization of stress management by combining high-dimensional biometric data analysis and anomaly detection algorithms by AI. Specific application fields include stress monitoring for the elderly, stress management for mental disorder patients, workplace mental health support, and health management in nursing care facilities. Furthermore, the stress analysis unit can integrate and manage the stress history of multiple users on the cloud, enabling personalized optimization of stress management advice and alert criteria. Thus, the stress analysis unit has high technical value in novelty and inventive step, contributing not only to the automation of human tasks but also to the improvement of computer technology itself and the solution of social issues.

The health risk reduction system may further include a social interaction analysis unit that acquires the user's social interaction data and analyzes the risk of social isolation. The social interaction analysis unit records, for example, the frequency of the user's phone calls and messages and detects changes in social interaction. If social interaction decreases, the risk of loneliness may increase, so an alert can be issued. For example, the social interaction analysis unit records the frequency of the user's phone calls and messages and detects changes in social interaction by comparing with past data. The social interaction analysis unit can also provide appropriate social interaction advice based on the user's social interaction data. Furthermore, the social interaction analysis unit can propose activities to prevent social isolation based on the user's social interaction data. This is expected to help reduce health risks due to social isolation and support the user's health maintenance. Specifically, the social interaction analysis unit accepts as input call history data obtained from the user's smartphone or communication app (e.g., 2 phone calls per day, 10 messages per week), SNS posting frequency, and conversation topic labels (e.g., family, friends, hobbies) in multidimensional vector format. The social interaction analysis unit accumulates these interaction data over time and uses time-series analysis models such as LSTM or Transformer and frequency analysis algorithms (e.g., Apriori method) to extract changes in social interaction and trends in isolation risk (e.g., decrease in interaction frequency, disappearance of specific topics). Examples of input include “number of phone calls over the past 7 days: 2→2→1→1→0→0→0 ,” “number of messages: 10→8→5→3→1→0→0 ,” etc. The AI model generates outputs such as “trend of decreased social interaction: present,” “isolation risk score: 0.87.” Based on these outputs, the social interaction analysis unit applies threshold judgment algorithms (e.g., weekly interaction frequency decreases by 50% or more compared to monthly average) or anomaly detection models to determine whether to issue an alert. Output examples include “alert: decreased social interaction,” “recommended advice: contact family or friends,” etc. Furthermore, by considering user attributes such as age, living environment, and health status, individually optimized social interaction advice and activities to prevent isolation (e.g., participation in hobby groups, guidance to local events) can also be generated. These advices are linked to the voice assist unit or notification module and provided to the user terminal in real time. As a technical effect, the social interaction analysis unit, unlike conventional manual recording or subjective evaluation by humans, realizes high-precision and early detection of changes in social interaction and maintenance of social connections by combining high-dimensional interaction data analysis and anomaly detection algorithms by AI. Specific application fields include prevention of isolation for the elderly, monitoring of social interaction for mental disorder patients, promotion of interaction in nursing care facilities, and regional monitoring networks. Furthermore, the social interaction analysis unit can integrate and manage the interaction history of multiple users on the cloud, enabling personalized optimization of interaction advice and activity proposals. Thus, the social interaction analysis unit has high technical value in novelty and inventive step, contributing not only to the automation of human tasks but also to the improvement of computer technology itself and the solution of social issues.

The health risk reduction system may further include a music provision unit that estimates the user's emotion and provides music based on the estimated emotion. For example, when the user is feeling stressed, the music provision unit provides relaxing music. When the user is relaxed, the music provision unit can provide uplifting music. Furthermore, when the user is feeling sad, the music provision unit can provide music that soothes the mood. By providing appropriate music based on emotion, the user's emotions can be stabilized and health maintenance can be supported. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the music provision unit may be performed using AI or without using AI. For example, the music provision unit can input the user's emotion data into generative AI and provide music based on emotion. Specifically, the music provision unit inputs the user's voice waveform data (e.g., 16 kHz sampling, 16 bit PCM, 10 seconds of audio), facial image data (e.g., 30 fps, 640×480 pixels), and text data (e.g., “I am tired today,” “I feel sad”) into an emotion estimation module. The music provision unit uses a multimodal emotion estimation model based on convolutional neural networks, LSTM, or Transformer to integrate acoustic features (e.g., F0, energy), facial features (e.g., degree of mouth corner drop, degree of eye opening), and text features (e.g., frequency of negative and positive words), and outputs emotion labels (e.g., stress, relaxation, sadness) and emotion scores (e.g., stress 0.82, relaxation 0.15, sadness 0.60). Examples of input include “voice: speech with sighs,” “facial expression: teary eyes,” “text: I am sad today,” etc. The AI model outputs scores such as “stress: 0.85,” “sadness: 0.70.” The music provision unit uses these emotion scores for threshold judgment (e.g., stress score of 0.8 or higher: relaxing music; relaxation score of 0.7 or higher: up-tempo music; sadness score of 0.7 or higher: healing music), and dynamically controls the music selection algorithm (e.g., genre classification, tempo estimation, acoustic feature matching) of the music recommendation module. For example, in a stress state, “healing music (BPM 60 or less, including natural sounds)” is automatically selected; in a relaxed state, “up-tempo pop music” is selected; and in a sad state, “gentle melody classical music” is selected. Output examples include “recommended music: healing music,” “recommended music: up-tempo pop,” etc. These music selections are delivered to the music playback module of the user terminal and played in real time. In subsequent processing, the user's playback history and emotional changes during music listening are accumulated by the recording unit and used for improving recommendation accuracy and personalization in the future. As a technical effect, the music provision unit, unlike conventional uniform music playback or manual selection by humans, automates individually optimized music provision tailored to the user's psychological state and usage situation by combining high-dimensional emotion estimation and music recommendation algorithms by AI. This enables stress reduction, mood stabilization, promotion of behavioral change, and qualitative improvement of health maintenance for the user. Specific application fields include psychological care for the elderly, mood management for mental disorder patients, relaxation support in nursing care facilities, and improvement of QOL for home care patients. Furthermore, the music provision unit can integrate and manage the emotion and music history of multiple users on the cloud, enabling personalized optimization of music recommendations and playback policies. Thus, the music provision unit has high technical value in novelty and inventive step, contributing not only to the automation of human tasks but also to the improvement of computer technology itself (e.g., improved recommendation accuracy, processing speed, qualitative improvement of user experience) and the solution of social issues.

The health risk reduction system may further include a relaxation provision unit that estimates the user's emotion and provides relaxation techniques based on the estimated emotion. For example, when the user is feeling stressed, the relaxation provision unit provides guides for deep breathing or meditation. When the user is nervous, the relaxation provision unit can provide guides for progressive muscle relaxation. Furthermore, when the user is anxious, the relaxation provision unit can provide guides for mindfulness. By providing appropriate relaxation techniques based on emotion, the user's stress can be reduced and health maintenance can be supported. Emotion estimation is realized, for example, by using an emotion estimation function employing an emotion engine or generative AI. Generative AI may include text generation AI (e.g., LLM) or multimodal generative AI, but is not limited to these examples. Some or all of the above-described processing in the relaxation provision unit may be performed using AI or without using AI. For example, the relaxation provision unit can input the user's emotion data into generative AI and provide relaxation techniques based on emotion. Specifically, the relaxation provision unit inputs the user's voice waveform data (e.g., 16 kHz sampling, 16 bit PCM, 10 seconds of audio), facial image data (e.g., 30 fps, 640×480 pixels), and text data (e.g., “I am nervous,” “I am anxious”) into an emotion estimation module. The relaxation provision unit uses a multimodal emotion estimation model based on convolutional neural networks, LSTM, or Transformer to integrate acoustic features (e.g., F0, energy), facial features (e.g., degree of eye opening, movement of mouth corners), and text features (e.g., frequency of negative words), and outputs emotion labels (e.g., stress, nervousness, anxiety) and emotion scores (e.g., stress 0.80, nervousness 0.75, anxiety 0.70). Examples of input include “voice: fast and nervous speech,” “facial expression: eyes wide open,” “text: I am anxious,” etc. The AI model outputs scores such as “stress: 0.85,” “anxiety: 0.72.” The relaxation provision unit uses these emotion scores for threshold judgment (e.g., stress score of 0.8 or higher: deep breathing guide; nervousness score of 0.7 or higher: progressive muscle relaxation guide; anxiety score of 0.7 or higher: mindfulness guide), and dynamically controls the guide generation algorithm (e.g., template selection, speech synthesis, video guide generation) of the relaxation technique selection module. For example, in a stress state, “guide for deep breathing with audio and animation” is automatically generated; in a nervous state, “practical guide for progressive muscle relaxation” is generated; and in an anxious state, “guided audio for mindfulness meditation” is generated. Output examples include “guide content: deep breathing induction,” “guide content: progressive muscle relaxation practice,” etc. These guides are delivered to the audio/video playback module of the user terminal and provided in real time. In subsequent processing, the user's guide implementation history and emotional changes are accumulated by the recording unit and used for optimization and personalization of future guides. As a technical effect, the relaxation provision unit, unlike conventional uniform guides or manual selection by humans, automates individually optimized provision of relaxation techniques tailored to the user's psychological state and usage situation by combining high-dimensional emotion estimation and relaxation technique recommendation algorithms by AI. This enables stress reduction, enhancement of relaxation effects, and qualitative improvement of health maintenance for the user. Specific application fields include stress care for the elderly, anxiety management for mental disorder patients, relaxation support in nursing care facilities, and improvement of QOL for home care patients. Furthermore, the relaxation provision unit can integrate and manage the emotion and guide history of multiple users on the cloud, enabling personalized optimization of relaxation techniques and guide policies. Thus, the relaxation provision unit has high technical value in novelty and inventive step, contributing not only to the automation of human tasks but also to the improvement of computer technology itself (e.g., improved recommendation accuracy, processing speed, qualitative improvement of user experience) and the solution of social issues.

The health risk reduction system may include an exercise recommendation unit configured to estimate a user's emotion and propose appropriate exercises based on the estimated emotion. The exercise recommendation unit, for example, may propose relaxing yoga or stretching when the user is feeling stressed. Additionally, the exercise recommendation unit may propose running or aerobics when the user is energetic. Furthermore, when the user is fatigued, the exercise recommendation unit may propose light walking or relaxation exercises. By proposing appropriate exercises based on emotion, it is expected to contribute to the maintenance of the user's health. Emotion estimation may be implemented using an emotion estimation function, for example, by employing an emotion engine or generative AI. The generative AI may be a text generation AI (e.g., LLM) or a multimodal generative AI, but is not limited to these examples. Some or all of the above-described processes in the exercise recommendation unit may be performed using AI or without using AI. For example, the exercise recommendation unit may input the user's emotion data into a generative AI and propose exercises based on the emotion. Specifically, the exercise recommendation unit inputs the user's voice waveform data (e.g., 16 kHz sampling, 16 bit PCM, 10 seconds of audio), facial image data (e.g., 30 fps, 640×480 pixels), and text data (e.g., “I am tired today”, “I am energetic”) into an emotion estimation module. The exercise recommendation unit integrates acoustic features (e.g., F0, energy), facial features (e.g., degree of mouth corner lift, eye opening/closing), and text features (e.g., frequency of negative words, frequency of positive words) using a multimodal emotion estimation model based on convolutional neural networks, LSTM, or Transformer, and outputs emotion labels (e.g., stress, energetic, fatigue) and emotion scores (e.g., stress 0.80, energetic 0.75, fatigue 0.70). Examples of input include “Voice: lively utterance”, “Facial expression: smile”, “Text: I am motivated today”. The AI model outputs scores such as “Energetic: 0.85”, “Fatigue: 0.72”. The exercise recommendation unit uses these emotion scores for threshold judgment (e.g., yoga/stretching for stress score of 0.8 or higher, running/aerobics for energetic score of 0.7 or higher, walking/relaxation exercises for fatigue score of 0.7 or higher), and dynamically controls the exercise selection algorithm of the exercise recommendation module (e.g., exercise intensity classification, reference to exercise history, linkage with health status, etc.). For example, in a stress state, “yoga (20 minutes)” or “stretching (10 minutes)” is automatically proposed; in an energetic state, “running (30 minutes)” or “aerobics (20 minutes)”; in a fatigue state, “walking (15 minutes)” or “light calisthenics” are automatically proposed. Examples of output include “Recommended exercise: yoga 20 minutes”, “Recommended exercise: running 30 minutes”. These exercise recommendations are delivered to the notification module or voice assist unit of the user terminal and guided in real time. As a subsequent process, the user's exercise implementation history and emotional changes are accumulated by the recording unit and utilized for optimization and personalization of future recommendations. As a technical effect, the exercise recommendation unit, unlike conventional uniform exercise recommendations or manual selection by humans, automates individually optimized exercise recommendations tailored to the user's psychological state and usage situation by combining high-dimensional emotion estimation by AI and exercise recommendation algorithms. This enables the establishment of exercise habits, maintenance of health, improvement of mood, and promotion of behavioral change for the user. Specific application fields include exercise support for the elderly, prevention of lifestyle-related diseases, rehabilitation, and exercise management in nursing care facilities. Furthermore, the exercise recommendation unit can integrate and manage the emotions and exercise histories of multiple users on the cloud, enabling personalization of individually optimized exercise recommendations and implementation guides. Thus, the exercise recommendation unit possesses high novelty and inventive technical value that contributes not only to the automation of human tasks but also to the improvement of computer technology itself (e.g., improved recommendation accuracy, increased processing speed, qualitative enhancement of user experience) and the resolution of social issues.

The health risk reduction system may include a meal recommendation unit configured to estimate a user's emotion and propose appropriate meals based on the estimated emotion. The meal recommendation unit, for example, may propose relaxing herbal tea or light snacks when the user is feeling stressed. Additionally, the meal recommendation unit may propose highly nutritious meals when the user is energetic. Furthermore, when the user is fatigued, the meal recommendation unit may propose easily digestible meals. By proposing appropriate meals based on emotion, it is expected to contribute to the maintenance of the user's health. Emotion estimation may be implemented using an emotion estimation function, for example, by employing an emotion engine or generative AI. The generative AI may be a text generation AI (e.g., LLM) or a multimodal generative AI, but is not limited to these examples. Some or all of the above-described processes in the meal recommendation unit may be performed using AI or without using AI. For example, the meal recommendation unit may input the user's emotion data into a generative AI and propose meals based on the emotion. Specifically, the meal recommendation unit inputs the user's voice waveform data (e.g., 16 kHz sampling, 16 bit PCM, 10 seconds of audio), facial image data (e.g., 30 fps, 640×480 pixels), and text data (e.g., “I am tired today”, “I am energetic”) into an emotion estimation module. The meal recommendation unit integrates acoustic features (e.g., F0,energy), facial features (e.g., degree of mouth corner lift, eye opening/closing), and text features (e.g., frequency of negative words, frequency of positive words) using a multimodal emotion estimation model based on convolutional neural networks, LSTM, or Transformer, and outputs emotion labels (e.g., stress, energetic, fatigue) and emotion scores (e.g., stress 0.80, energetic 0.75, fatigue 0.70). Examples of input include “Voice: lively utterance”, “Facial expression: smile”, “Text: I am motivated today”. The AI model outputs scores such as “Energetic: 0.85”, “Fatigue: 0.72”. The meal recommendation unit uses these emotion scores for threshold judgment (e.g., herbal tea/light snacks for stress score of 0.8 or higher, highly nutritious meals for energetic score of 0.7 or higher, easily digestible meals for fatigue score of 0.7 or higher), and dynamically controls the menu selection algorithm of the meal recommendation module (e.g., nutrient classification, reference to meal history, linkage with health status, etc.). For example, in a stress state, “chamomile tea”, “yogurt”, or “banana” is automatically proposed; in an energetic state, “grilled chicken breast”, “salad bowl”, or “brown rice”; in a fatigue state, “rice porridge”, “miso soup”, or “steamed vegetables” are automatically proposed. Examples of output include “Recommended meal: chamomile tea”, “Recommended meal: grilled chicken breast”. These meal recommendations are delivered to the notification module or voice assist unit of the user terminal and guided in real time. As a subsequent process, the user's meal implementation history and emotional changes are accumulated by the recording unit and utilized for optimization and personalization of future recommendations. As a technical effect, the meal recommendation unit, unlike conventional uniform meal recommendations or manual selection by humans, automates individually optimized meal recommendations tailored to the user's psychological state and usage situation by combining high-dimensional emotion estimation by AI and meal menu recommendation algorithms. This enables improvement of nutritional balance, maintenance of health, mood stabilization, and promotion of behavioral change for the user. Specific application fields include nutritional management for the elderly, prevention of lifestyle-related diseases, diet support, and meal management in nursing care facilities. Furthermore, the meal recommendation unit can integrate and manage the emotions and meal histories of multiple users on the cloud, enabling personalization of individually optimized meal recommendations and menu policies. Thus, the meal recommendation unit possesses high novelty and inventive technical value that contributes not only to the automation of human tasks but also to the improvement of computer technology itself (e.g., improved recommendation accuracy, increased processing speed, qualitative enhancement of user experience) and the resolution of social issues.

The health risk reduction system may include a communication recommendation unit configured to estimate a user's emotion and propose appropriate communication methods based on the estimated emotion. The communication recommendation unit, for example, may propose relaxing topics or methods when the user is feeling stressed. Additionally, the communication recommendation unit may propose active topics or methods when the user is energetic. Furthermore, when the user is fatigued, the communication recommendation unit may propose gentle topics or methods. By proposing appropriate communication methods based on emotion, it is expected to reduce the user's stress and contribute to the maintenance of health. Emotion estimation may be implemented using an emotion estimation function, for example, by employing an emotion engine or generative AI. The generative AI may be a text generation AI (e.g., LLM) or a multimodal generative AI, but is not limited to these examples. Some or all of the above-described processes in the communication recommendation unit may be performed using AI or without using AI. For example, the communication recommendation unit may input the user's emotion data into a generative AI and propose communication methods based on the emotion. Specifically, the communication recommendation unit inputs the user's voice waveform data (e.g., 16 kHz sampling, 16 bit PCM, 10 seconds of audio), facial image data (e.g., 30 fps, 640×480 pixels), and text data (e.g., “I am tired today”, “I am energetic”) into an emotion estimation module. The communication recommendation unit integrates acoustic features (e.g., F0, energy), facial features (e.g., degree of mouth corner lift, eye opening/closing), and text features (e.g., frequency of negative words, frequency of positive words) using a multimodal emotion estimation model based on convolutional neural networks, LSTM, or Transformer, and outputs emotion labels (e.g., stress, energetic, fatigue) and emotion scores (e.g., stress 0.80, energetic 0.75, fatigue 0.70). Examples of input include “Voice: lively utterance”, “Facial expression: smile”, “Text: I am motivated today”. The AI model outputs scores such as “Energetic: 0.85”, “Fatigue: 0.72”. The communication recommendation unit uses these emotion scores for threshold judgment (e.g., relaxing topics/methods for stress score of 0.8 or higher, active topics/methods for energetic score of 0.7 or higher, gentle topics/methods for fatigue score of 0.7 or higher), and dynamically controls the topic/method selection algorithm of the communication recommendation module (e.g., reference to conversation history, topic classification, dialogue template selection, etc.). For example, in a stress state, “casual conversation about hobbies or nature” or “relaxing voice call” is automatically proposed; in an energetic state, “topics about sports or travel” or “group chat”; in a fatigue state, “gentle conversation with family” or “short messages” are automatically proposed. Examples of output include “Recommended method: relaxing chat”, “Recommended method: group chat”. These communication recommendations are delivered to the notification module or voice assist unit of the user terminal and guided in real time. As a subsequent process, the user's communication implementation history and emotional changes are accumulated by the recording unit and utilized for optimization and personalization of future recommendations. As a technical effect, the communication recommendation unit, unlike conventional uniform recommendations or manual selection by humans, automates individually optimized communication method recommendations tailored to the user's psychological state and usage situation by combining high-dimensional emotion estimation by AI and communication method recommendation algorithms. This enables stress reduction, promotion of social interaction, mood stabilization, and qualitative improvement of health maintenance for the user. Specific application fields include prevention of isolation among the elderly, support for interaction among patients with mental disorders, promotion of conversation in nursing care facilities, and improvement of QOL for home care patients. Furthermore, the communication recommendation unit can integrate and manage the emotions and interaction histories of multiple users on the cloud, enabling personalization of individually optimized communication recommendations and interaction policies. Thus, the communication recommendation unit possesses high novelty and inventive technical value that contributes not only to the automation of human tasks but also to the improvement of computer technology itself (e.g., improved recommendation accuracy, increased processing speed, qualitative enhancement of user experience) and the resolution of social issues.

The following is a brief description of the processing flow of Example of the Embodiment. Specifically, the present system adopts a configuration in which multiple modules such as a recording unit, an analysis unit, a provision unit, and a voice assist unit operate in cooperation. The system acquires the user's conversation data (e.g., voice waveform data, text data, conversation occurrence time, speaker attributes, etc.) in a multidimensional vector format via the recording unit and stores it in a database in real time. The recording unit uses a speech recognition engine and a natural language processing module to extract features such as text conversion of conversation content, speaking speed (e.g., number of words per unit time), and grammatical structure analysis (e.g., dependency parsing, part-of-speech frequency distribution). The analysis unit inputs the conversation data received from the recording unit into a time-series analysis model based on LSTM or Transformer, and analyzes with high accuracy the trends in grammatical error rates, changes in speaking speed, and emotion estimation (e.g., scoring of tension, relaxation, stress, etc.). Examples of input include “speaking speed over the past 7 days: 120 wpm→110 wpm→100 wpm”, “grammatical error rate: 2%→3%→5%”, “emotion score: tension 0.75”. The AI model generates outputs such as “trend of decreased speaking speed: present”, “trend of increased grammatical errors: present”, “emotional change: increased tension”. The analysis unit applies threshold judgment algorithms (e.g., speaking speed decreases by 20% or more in one week, grammatical error rate exceeds 5%, etc.) and anomaly detection models (e.g., Isolation Forest, etc.) based on these outputs to determine whether to issue an alert and its priority. The provision unit automatically generates alert content (e.g., voice alert, text alert, email alert, etc.) with an alert generation module based on the analysis result, and delivers it in real time to family members, medical personnel, and user terminals via a notification module. The alert content is dynamically controlled according to the type and urgency of the analysis result, such as template selection and style control parameters (e.g., tone, amount of information, sentence length, etc.). The voice assist unit optimizes the tone, pitch, and speed of a friendly voice using a voice synthesis module (e.g., WaveNet or Tacotron, etc.) based on the user's conversation history and emotional information, and generates natural conversational speech such as “Good morning, what plans do you have today?”. As a subsequent process, the user's response and emotional changes are reacquired by the recording unit and utilized for future conversation optimization and health risk analysis. As a technical effect, the present system, unlike conventional manual recording or uniform notification, realizes early detection of health risks, rapid response, and qualitative improvement of user experience by combining high-dimensional conversation data analysis, anomaly detection, and voice generation algorithms by AI. Specific application fields include monitoring of cognitive function in the elderly, analysis of conversation patterns in patients with mental disorders, health management in nursing care facilities, and remote medical support. Furthermore, the present system can integrate and manage the conversation, analysis, and alert histories of multiple users on the cloud, enabling personalization of individually optimized notification and conversation policies. Thus, the present system possesses high novelty and inventive technical value that contributes not only to the automation of human tasks but also to the improvement of computer technology itself and the resolution of social issues.
Step 1: The recording unit records conversation data. The conversation data includes content of the conversation, speaking speed, and grammatical differences. The recording unit automatically records the content of the conversation and stores it as data. It can also measure the speaking speed and store it as data. Furthermore, it can detect grammatical differences and store them as data.
Step 2: The analysis unit analyzes the conversation data recorded by the recording unit. The analysis unit analyzes an increase in grammatical differences and a decrease in speaking speed. It also performs emotion analysis and can detect changes in emotion during the conversation. For example, an increase in grammatical differences is measured as a change in error rate, and a decrease in speaking speed is measured as a reduction in the number of words per unit time. Emotion analysis is performed using voice tone and facial expression analysis.
Step 3: The provision unit provides an alert based on the analysis result obtained by the analysis unit. The provision unit issues an alert based on the analysis result. The alert is provided according to the notification method and type of alert. For example, an alert may be sent to family members or medical personnel. Types of alerts include voice alerts, text alerts, and email alerts.
Step 4: The voice assist unit speaks in a friendly voice. The voice assist unit adjusts the tone, pitch, and speed of the friendly voice. For example, it speaks in a friendly voice, saying “Good morning, what plans do you have today?”.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT® (Internet search <URL:

https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned recording unit, analysis unit, provision unit, and voice assist unit is implemented by at least one of, for example, a smart device 14 and a data processing apparatus 12. For example, the recording unit is implemented by a computer 36 of the smart device 14, and records conversation data and stores it as data. The analysis unit is implemented, for example, by a specific processing unit 290 of the data processing apparatus 12, and analyzes the recorded conversation data. The provision unit is implemented, for example, by the specific processing unit 290 of the data processing apparatus 12, and provides an alert based on the analysis result. The voice assist unit is implemented, for example, by a control unit 46A of the smart device 14, and speaks in a friendly voice. The correspondence between each unit and the device or control unit is not limited to the examples described above, and various modifications are possible.

### Second Embodiment

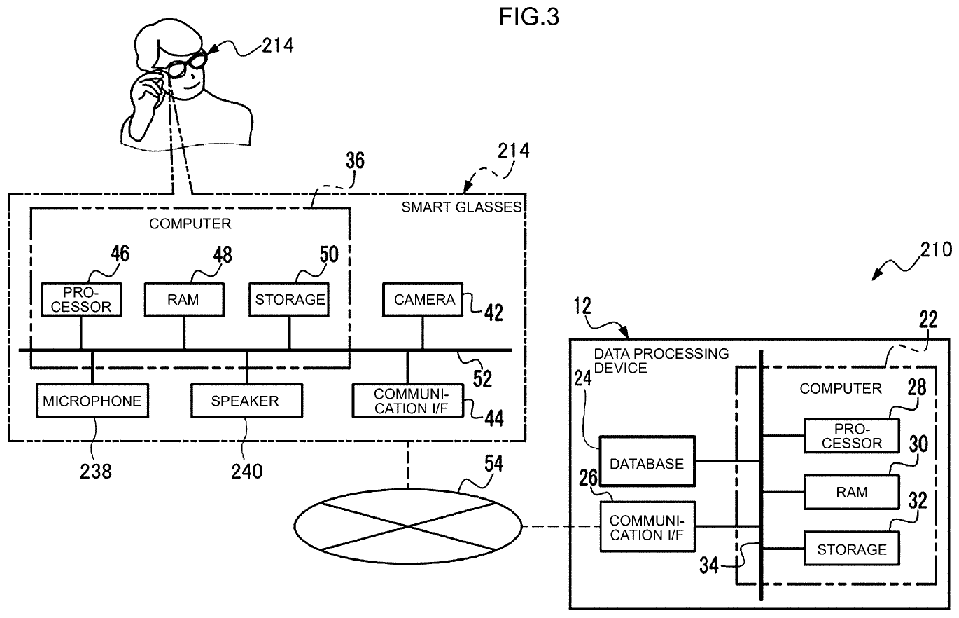

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

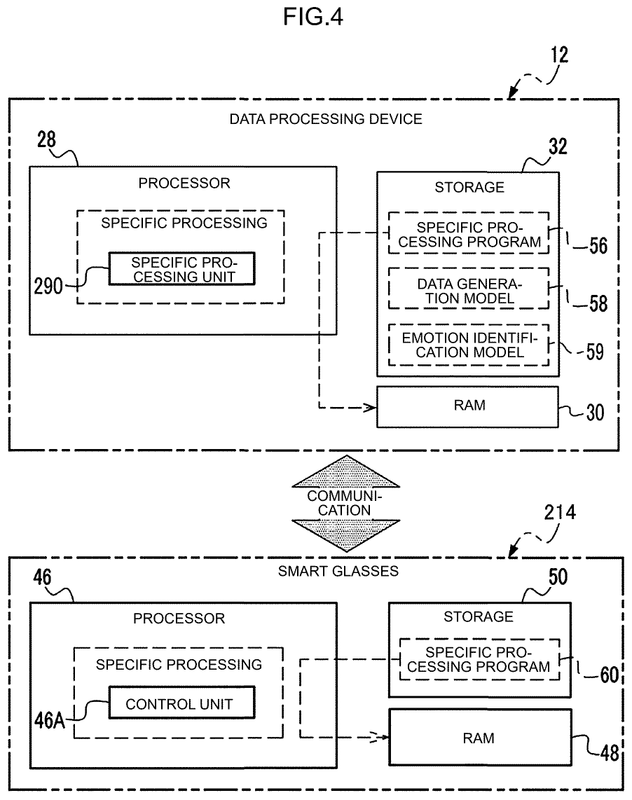

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned recording unit, analysis unit, provision unit, and voice assist unit is implemented by at least one of, for example, smart glasses 214 and a data processing apparatus 12. For example, the recording unit is implemented by a computer 36 of the smart glasses 214, and records conversation data and stores it as data. The analysis unit is implemented, for example, by a specific processing unit 290 of the data processing apparatus 12, and analyzes the recorded conversation data. The provision unit is implemented, for example, by the specific processing unit 290 of the data processing apparatus 12, and provides an alert based on the analysis result. The voice assist unit is implemented, for example, by a control unit 46A of the smart glasses 214, and speaks in a friendly voice. The correspondence between each unit and the device or control unit is not limited to the examples described above, and various modifications are possible.

### Third Embodiment

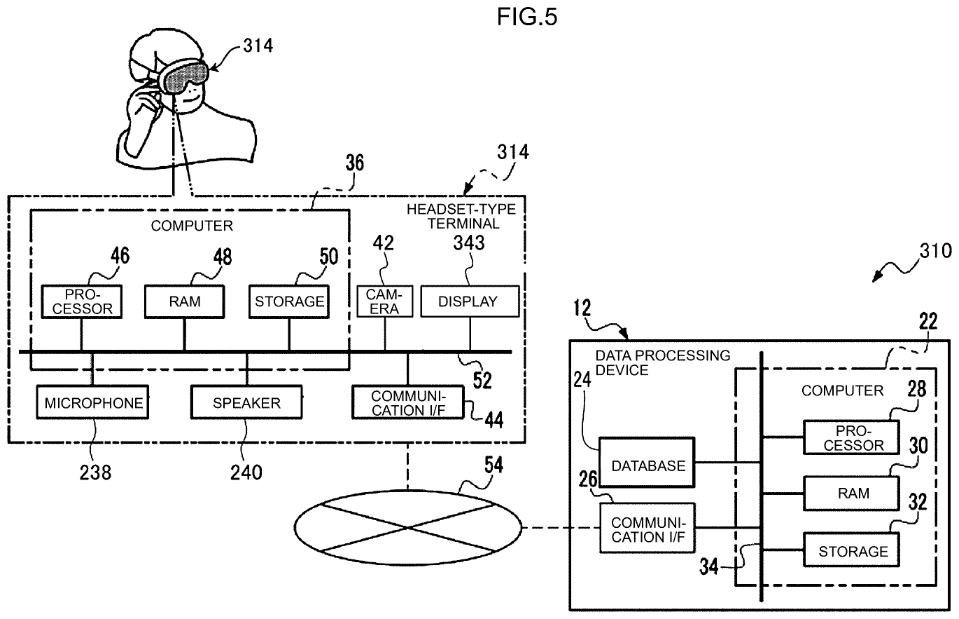

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

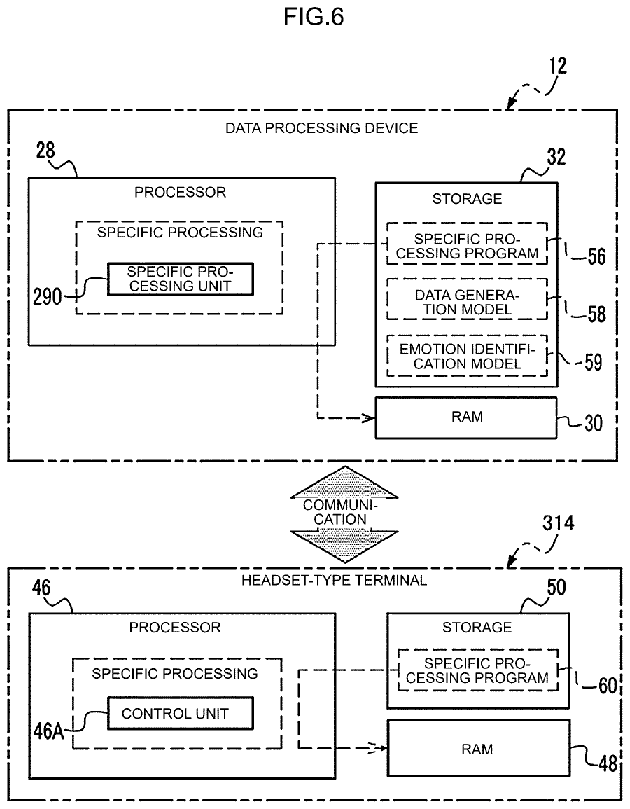

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned recording unit, analysis unit, provision unit, and voice assist unit is implemented by at least one of, for example, a headset-type terminal 314 and a data processing apparatus 12. For example, the recording unit is implemented by a computer 36 of the headset-type terminal 314, and records conversation data and stores it as data. The analysis unit is implemented, for example, by a specific processing unit 290 of the data processing apparatus 12, and analyzes the recorded conversation data. The provision unit is implemented, for example, by the specific processing unit 290 of the data processing apparatus 12, and provides an alert based on the analysis result. The voice assist unit is implemented, for example, by a control unit 46A of the headset-type terminal 314, and speaks in a friendly voice. The correspondence between each unit and the device or control unit is not limited to the examples described above, and various modifications are possible.

### Fourth Embodiment

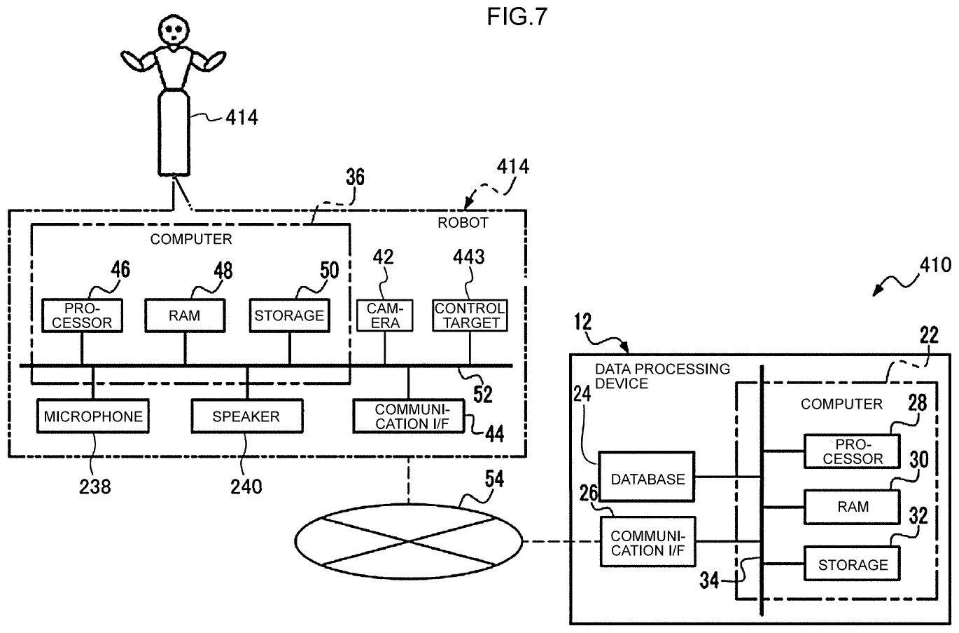

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

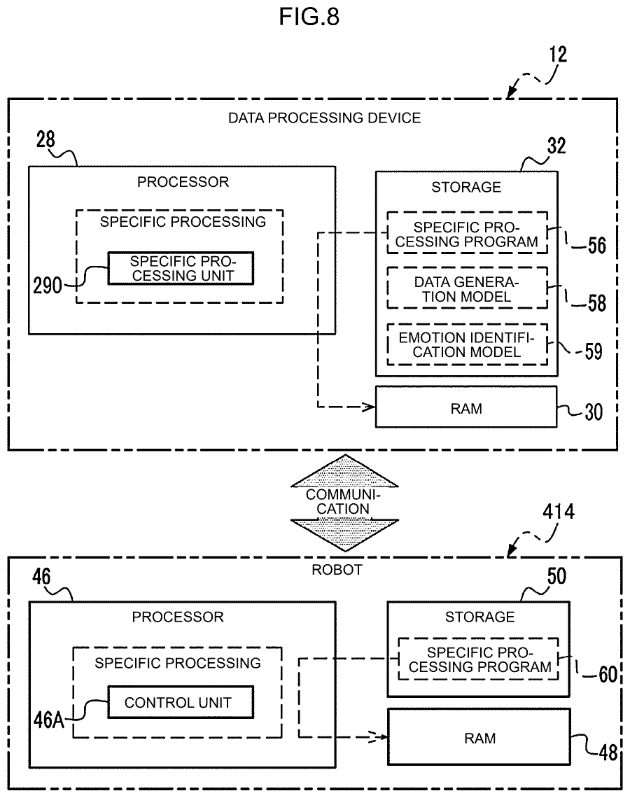

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned recording unit, analysis unit, provision unit, and voice assist unit is implemented by at least one of, for example, a robot 414 and a data processing apparatus 12. For example, the recording unit is implemented by a computer 36 of the robot 414, and records conversation data and stores it as data. The analysis unit is implemented, for example, by a specific processing unit 290 of the data processing apparatus 12, and analyzes the recorded conversation data. The provision unit is implemented, for example, by the specific processing unit 290 of the data processing apparatus 12, and provides an alert based on the analysis result. The voice assist unit is implemented, for example, by a control unit 46A of the robot 414, and speaks in a friendly voice. The correspondence between each unit and the device or control unit is not limited to the examples described above, and various modifications are possible.

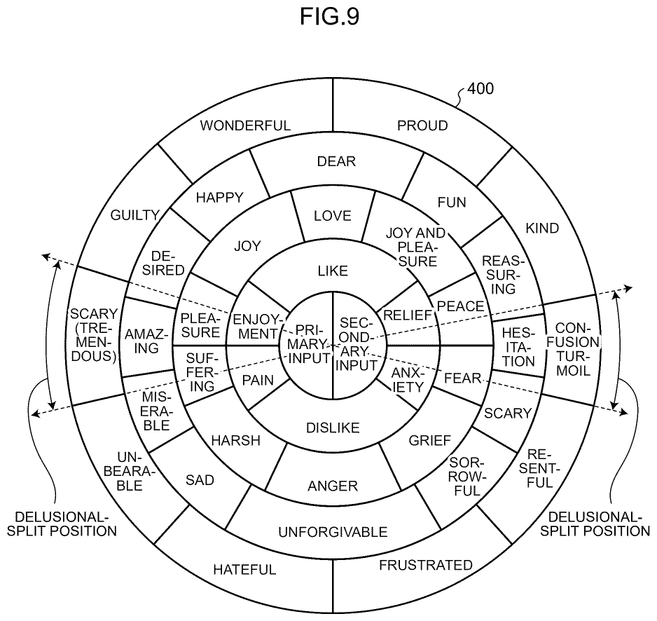

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

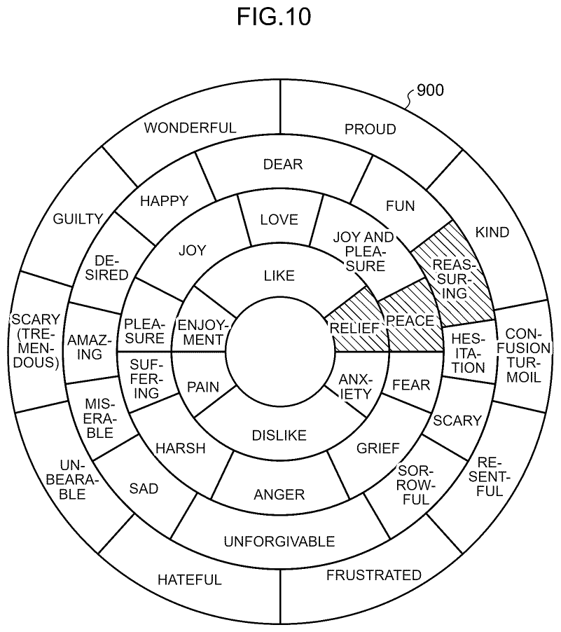

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a recording unit configured to record conversation data; an analysis unit configured to analyze the conversation data recorded by the recording unit; a provision unit configured to provide an alert based on an analysis result obtained by the analysis unit; and a voice assist unit configured to speak in a friendly voice.
(Supplementary Note 2) The system according to Supplementary Note 1, wherein the recording unit is configured to record content of the conversation, speaking speed, or grammatical differences.
(Supplementary Note 3) The system according to Supplementary Note 1, wherein the analysis unit is configured to analyze an increase in grammatical differences or a decrease in speaking speed.
(Supplementary Note 4) The system according to Supplementary Note 1, wherein the analysis unit performs emotion analysis and detects changes in emotion during the conversation.
(Supplementary Note 5) The system according to Supplementary Note 1, wherein the provision unit issues an alert based on the analysis result.
(Supplementary Note 6) The system according to Supplementary Note 1, wherein the voice assist unit speaks in a friendly voice.
(Supplementary Note 7) The system according to Supplementary Note 1, wherein the recording unit estimates a user's emotion and adjusts the frequency of conversation recording based on the estimated emotion of the user.
(Supplementary Note 8) The system according to Supplementary Note 1, wherein the recording unit analyzes the user's past conversation history and selects an appropriate recording method.
(Supplementary Note 9) The system according to Supplementary Note 1, wherein the recording unit performs filtering during conversation recording based on the user's current health status or living conditions.
(Supplementary Note 10) The system according to Supplementary Note 1, wherein the recording unit estimates a user's emotion and determines the priority of conversations to be recorded based on the estimated emotion of the user.
(Supplementary Note 11) The system according to Supplementary Note 1, wherein the recording unit considers the user's geographic location information during conversation recording and preferentially records highly relevant conversations.
(Supplementary Note 12) The system according to Supplementary Note 1, wherein the recording unit analyzes the user's social media activity during conversation recording and records relevant conversations.
(Supplementary Note 13) The system according to Supplementary Note 1, wherein the analysis unit estimates a user's emotion and adjusts the accuracy of analysis based on the estimated emotion of the user.
(Supplementary Note 14) The system according to Supplementary Note 1, wherein the analysis unit applies different analysis algorithms during analysis based on the content of the conversation.
(Supplementary Note 15) The system according to Supplementary Note 1, wherein the analysis unit refers to the user's past health data during analysis to improve the reliability of the analysis result.
(Supplementary Note 16) The system according to Supplementary Note 1, wherein the analysis unit estimates a user's emotion and adjusts the display method of the analysis result based on the estimated emotion of the user.
(Supplementary Note 17) The system according to Supplementary Note 1, wherein the analysis unit determines the priority of analysis during analysis based on the time zone of the conversation.
(Supplementary Note 18) The system according to Supplementary Note 1, wherein the analysis unit adjusts the order of analysis during analysis based on the relevance of the conversation.
(Supplementary Note 19) The system according to Supplementary Note 1, wherein the provision unit estimates a user's emotion and adjusts the content of the alert based on the estimated emotion of the user.
(Supplementary Note 20) The system according to Supplementary Note 1, wherein the provision unit refers to the user's past health history when providing an alert and selects optimal alert content.
(Supplementary Note 21) The system according to Supplementary Note 1, wherein the provision unit adjusts the timing of the alert when providing an alert based on the user's current living conditions.
(Supplementary Note 22) The system according to Supplementary Note 1, wherein the provision unit estimates a user's emotion and determines the priority of the alert based on the estimated emotion of the user.
(Supplementary Note 23) The system according to Supplementary Note 1, wherein the provision unit considers the user's geographic location information when providing an alert and selects optimal alert content.
(Supplementary Note 24) The system according to Supplementary Note 1, wherein the provision unit analyzes the user's social media activity when providing an alert and adjusts the content of the alert.
(Supplementary Note 25) The system according to Supplementary Note 1, wherein the voice assist unit estimates a user's emotion and adjusts the tone and tempo of the voice based on the estimated emotion of the user.
(Supplementary Note 26) The system according to Supplementary Note 1, wherein the voice assist unit refers to the user's past conversation history during voice assistance and selects an optimal way of speaking.
(Supplementary Note 27) The system according to Supplementary Note 1, wherein the voice assist unit customizes the content of speech during voice assistance based on the user's current health status.
(Supplementary Note 28) The system according to Supplementary Note 1, wherein the voice assist unit estimates a user's emotion and determines the priority of voice assistance based on the estimated emotion of the user.
(Supplementary Note 29) The system according to Supplementary Note 1, wherein the voice assist unit considers the user's geographic location information during voice assistance and selects an optimal way of speaking.
(Supplementary Note 30) The system according to Supplementary Note 1, wherein the voice assist unit analyzes the user's social media activity during voice assistance and adjusts the content of speech.

What is claimed is:

1. A system comprising:
circuitry configured to:
receive, via a communication interface coupled to a packet-switched network, multimodal input data comprising voice waveform data sampled as a one-dimensional array and image data from a terminal device;
process the voice waveform data using a speech recognition model comprising a Transformer-based encoder to generate a token sequence, and compute temporal feature data comprising a token rate value and a syntactic deviation score from the token sequence;
determine, using an emotion identification model comprising a multimodal neural network that integrates a convolutional neural network for the image data and a long short-term memory network for acoustic feature vectors extracted from the voice waveform data, an emotion label output as a probability distribution over a plurality of emotion categories;
generate, by inputting the temporal feature data and the emotion label into an anomaly detection model, notification data comprising an anomaly score and a notification label; and
generate, using a neural speech synthesis model that receives the emotion label and a text input, synthesized voice data with acoustic parameters adjusted based on the emotion label, and transmit the synthesized voice data to the terminal device via the communication interface.

2. The system according to claim 1, wherein the multimodal input data further comprises text data, and wherein the speech recognition model converts the voice waveform data into the text data via a voice recognition engine and provides the text data as an input tensor comprising a token identifier sequence to the Transformer-based encoder.

3. The system according to claim 1, wherein the voice waveform data is sampled at 16 kHz as a one-dimensional array of 16-bit pulse-code modulation values.

4. The system according to claim 1, wherein the token rate value comprises a number of tokens per unit time computed from the token sequence, and wherein the syntactic deviation score comprises a count of syntactic errors detected by a natural language processing module that performs dependency parsing and part-of-speech tagging on the token sequence.

5. The system according to claim 1, wherein the plurality of emotion categories comprises at least a stress category, a relaxation category, and a hurry category, and wherein the emotion label comprises an emotion score for each of the plurality of emotion categories.

6. The system according to claim 1, wherein the anomaly detection model comprises at least one of an Isolation Forest model or a One-Class Support Vector Machine, and wherein the anomaly score is generated by comparing the temporal feature data against a historical baseline of the temporal feature data accumulated over a preceding time period.

7. The system according to claim 1, wherein the circuitry is further configured to adjust a recording frequency for the multimodal input data based on the emotion label, such that the recording frequency is reduced when the emotion label indicates a stress category and increased when the emotion label indicates a relaxation category.

8. The system according to claim 1, wherein the circuitry is further configured to analyze a conversation history database storing the token sequence in chronological order for each user, and select a recording policy comprising a priority recording topic and a concentrated recording time period based on a topic classification model that classifies the token sequence into a plurality of topic categories.

9. The system according to claim 1, wherein the circuitry is further configured to receive status data comprising at least one of a body temperature value, a blood pressure value, or a heart rate value from the terminal device, and apply a filtering policy to the multimodal input data based on the status data, the filtering policy selecting a subset of the multimodal input data for processing by the speech recognition model.

10. The system according to claim 1, wherein the circuitry is further configured to adjust an analysis parameter of the anomaly detection model based on the emotion label, the analysis parameter comprising at least one of a window size, a number of features, or a model depth, such that the analysis parameter is set to a high-accuracy configuration when the emotion label indicates the stress category and set to a simplified configuration when the emotion label indicates the hurry category.

11. The system according to claim 1, wherein the circuitry is further configured to classify the token sequence into a topic category using a topic classification model based on a Transformer, and select an analysis algorithm from a plurality of analysis algorithms based on the topic category, the plurality of analysis algorithms comprising a time-series risk estimation model, a life rhythm analysis model, and the emotion identification model.

12. The system according to claim 1, wherein the circuitry is further configured to retrieve time-series data comprising numerical vectors of the temporal feature data accumulated over a preceding period from a database, and compute a trend deviation value by applying a time-series analysis model comprising a long short-term memory network to the time-series data, and adjust a confidence indicator of the notification data based on the trend deviation value.

13. The system according to claim 1, wherein the circuitry is further configured to adjust a content template of the notification data based on the emotion label, such that the content template uses a gentle expression format when the emotion label indicates the stress category, a detailed information format when the emotion label indicates the relaxation category, and a concise format when the emotion label indicates the hurry category.

14. The system according to claim 1, wherein the circuitry is further configured to retrieve a historical record of the notification data from a database, and select optimal notification content by applying a deviation analysis algorithm and an anomaly detection algorithm to the historical record, and attach a reliability indicator comprising a confidence score and an anomaly detection label to the notification data.

15. The system according to claim 1, wherein the neural speech synthesis model comprises a WaveNet model or a Tacotron model, and wherein the acoustic parameters comprise at least a pitch value, a speed value, and a formant enhancement parameter, and wherein the circuitry is further configured to determine the acoustic parameters based on user attribute data comprising at least an age group and the emotion label.

16. The system according to claim 1, wherein the circuitry is further configured to receive location data comprising latitude and longitude coordinates from the terminal device, compute a relevance score between the token sequence and the location data using a geographic information analysis module and a topic classification model, and adjust a recording priority for the multimodal input data based on the relevance score.

17. The system according to claim 1, wherein the circuitry is further configured to generate, by inputting the emotion label into a recommendation model comprising at least one of a reinforcement-learning-based selection algorithm or a recurrent neural network, recommendation data comprising an activity identifier and a duration parameter, and transmit the recommendation data to the terminal device via the communication interface.

18. A system comprising:
circuitry configured to:
receive, via a communication interface coupled to a packet-switched network, multimodal input data comprising voice waveform data sampled at 16 kHz as a one-dimensional array of 16-bit pulse-code modulation values, image data as a two-dimensional pixel array captured by a camera of a terminal device, and text data extracted from the voice waveform data by a voice recognition engine;
process the voice waveform data using a speech recognition model comprising a Transformer-based encoder to generate a token sequence, and compute temporal feature data comprising a token rate value measured as a number of tokens per unit time and a syntactic deviation score measured as a count of syntactic errors detected by a natural language processing module performing dependency parsing and part-of-speech tagging;
extract, from the voice waveform data, acoustic feature vectors comprising a fundamental frequency, formant values, an energy value, and a spectral envelope;
determine, using an emotion identification model comprising a multimodal neural network that integrates a convolutional neural network receiving the image data, a long short-term memory network receiving the acoustic feature vectors, and a Transformer receiving text features extracted from the text data, an emotion label output as a probability distribution over a plurality of emotion categories comprising at least a stress category, a relaxation category, and a hurry category;
generate, by inputting the temporal feature data and the emotion label into an anomaly detection model comprising at least one of an Isolation Forest model or a One-Class Support Vector Machine, notification data comprising an anomaly score computed by comparing the temporal feature data against a historical baseline accumulated over a preceding time period, and a notification label selected from a plurality of notification labels based on a threshold applied to the anomaly score;
select a content template from a plurality of content templates based on the emotion label, the plurality of content templates comprising a gentle expression format associated with the stress category, a detailed information format associated with the relaxation category, and a concise format associated with the hurry category; and
generate, using a neural speech synthesis model comprising at least one of a WaveNet model or a Tacotron model, synthesized voice data by applying acoustic parameters comprising a pitch value, a speed value, and a formant enhancement parameter determined based on user attribute data and the emotion label, and transmit the synthesized voice data and the notification data to the terminal device via the communication interface.

19. The system according to claim 18, wherein the circuitry is further configured to classify the token sequence into a topic category using a topic classification model based on a Transformer, select an analysis algorithm from a plurality of analysis algorithms based on the topic category, and adjust an analysis parameter of the anomaly detection model based on the emotion label, the analysis parameter comprising at least one of a window size, a number of features, or a model depth.

20. A method performed by circuitry of a system, the method comprising:
receiving, via a communication interface coupled to a packet-switched network, multimodal input data comprising voice waveform data sampled as a one-dimensional array and image data from a terminal device;
processing the voice waveform data using a speech recognition model comprising a Transformer-based encoder to generate a token sequence, and computing temporal feature data comprising a token rate value and a syntactic deviation score from the token sequence;
determining, using an emotion identification model comprising a multimodal neural network that integrates a convolutional neural network for the image data and a long short-term memory network for acoustic feature vectors extracted from the voice waveform data, an emotion label output as a probability distribution over a plurality of emotion categories;
generating, by inputting the temporal feature data and the emotion label into an anomaly detection model, notification data comprising an anomaly score and a notification label; and
generating, using a neural speech synthesis model that receives the emotion label and a text input, synthesized voice data with acoustic parameters adjusted based on the emotion label, and transmitting the synthesized voice data to the terminal device via the communication interface.
